(19) United States
(12) Patent Application Publication
(10) Pub. No.: US 2013/0279586 A1
(43) Pub. Date: Oct. 24, 2013

(54) IMAGE PROCESSING DEVICE AND IMAGE PROCESSING METHOD

(71) Applicant: Kazushi Sato, Kanagawa (JP)

(72) Inventor: Kazushi Sato, Kanagawa (JP)

(21) Appl. No.: 13/825,860

(22) PCT Filed: Sep. 6, 2011
(86) PCT No.: PCT/JP11/70232

§ 371 Date: Mar. 25, 2013

(30) Foreign Application Priority Data
Oct. 1, 2010 (JP) 2010-224348

(51) Int. Cl. H04N 7/36

(52) U.S. Cl. CPC H04N 19/00684
USPC 375/240.16

(57) ABSTRACT

There is provided an image processing device including a motion vector determination section for partitioning a block set in an image into a plurality of partitions using a boundary having an inclination, and determining a motion vector for each partition, and a boundary information generation section for generating boundary information specifying a plurality of points of intersection of a perimeter of the block and the boundary.

### TECHNICAL FIELD

The present disclosure relates to an image processing device, and an image processing method.

### BACKGROUND ART

Conventionally, a compression technology is widespread that has its object to effectively transmit or accumulate digital images, and that compresses the amount of information of an image by motion compensation and orthogonal transform such as discrete cosine transform, for example, by using redundancy unique to the image. For example, an image encoding device and an image decoding device conforming to a standard technology such as H.26x standards developed by ITU-T or MPEG-y standards developed by MPEG (Moving Picture Experts Group) are widely used in various scenes, such as accumulation and distribution of images by a broadcaster and reception and accumulation of images by a general user.

MPEG2 (ISO/IEC 13818-2) is one of MPEG-y standards defined as a general-purpose image encoding method. MPEG2 is capable of handling both interlaced scanning images and non-interlaced images, and targets high-definition images, in addition to digital images in standard resolution. MPEG2 is currently widely used in a wide range of applications including professional uses and consumer uses. According to MPEG2, for example, by allocating a bit rate of 4 to 8 Mbps to an interlaced scanning image in standard resolution of 720×480 pixels and a bit rate of 18 to 22 Mbps to an interlaced scanning image in high resolution of 1920×1088 pixels, both a high compression ratio and a desirable image quality can be realized.

MPEG2 was primarily for high-quality encoding suitable for broadcasting use, and did not handle a bit rate lower than MPEG1, that is, a high compression ratio. However, with the spread of mobile terminals of recent years, the demand for an encoding method enabling a high compression ratio is increasing. Accordingly, standardization of an MPEG4 encoding method was newly promoted. With regard to an image encoding method which is a part of the MPEG4 encoding method, its standards were accepted as an international standard (ISO/IEC 14496-2) in December 1998.

The H.26x standards (ITU-T Q6/16 VCEG) are standards developed initially with the aim of performing encoding that is suitable for communications such as video telephones and video conferences. The H.26x standards are known to require a large computation amount for encoding and decoding, but to be capable of realizing a higher compression ratio, compared with the MPEG-y standards. Furthermore, with Joint Model of Enhanced-Compression Video Coding, which is a part of the activities of MPEG4, a standard allowing realization of a higher compression ratio by adopting a new function while being based on the H.26x standards is developed. This standard was made an international standard under the names of H.264 and MPEG-4 Part10 (Advanced Video Coding; AVC) in March 2003.

One important technique in the image encoding scheme described above is motion compensation. In the case an object is moving greatly in a series of images, a difference between an encoding target image and a reference image will be great, making it difficult to obtain a high compression ratio by simple inter-frame prediction. However, by recognizing the motion of the object and compensating the pixel value of a partition including the motion according to the motion, a prediction error of the inter-frame prediction can be reduced and the compression ratio can be increased. In MPEG2, motion compensation is performed taking 6×16 pixels as a processing unit in the case of a frame motion compensation mode, and taking 16×8 pixels as a processing unit for each of a first field and a second field in the case of a field motion compensation mode. Also, in H.264/AVC, a macro block whose size is 16×16 pixels can be partitioned into partitions of any of sizes 16×16 pixels, 16×8 pixels, 8×16 pixels and 8×8 pixels, and a motion vector can be individually set for each partition. Also, a partition of 8×8 pixels can be further partitioned into any of sizes 8×8 pixels, 8×4 pixels, 4×8 pixels and 4×4 pixels, and a motion vector can be set for each partition.

In many cases, a motion vector set for a certain partition is correlated with a motion vector set for a peripheral block or partition. For example, in the case one moving object is moving in a series of images, the motion vectors for a plurality of partitions belonging to the range where the moving object is shown are the same or at least similar. Also, a motion vector set for a certain partition may be correlated with a motion vector that is set for a corresponding partition in a reference image which is near in the temporal direction. Accordingly, the image encoding schemes such as MPEG4, H.264/AVC and the like aim to reduce the amount of information to be encoded by predicting a motion vector using the spatial correlation or temporal correlation of motion and encoding only the difference between the predicted motion vector and an actual motion vector. Also, Non-Patent Literature 1 mentioned below proposes to use both the spatial correlation and temporal correlation of motion in combination.

At the time of predicting a motion vector, another block or partition that is correlated with an encoding target partition has to be appropriately selected. A reference pixel position is used as the reference for the selection. The processing unit of motion compensation in an existing image encoding scheme generally has a rectangular shape. Thus, normally, a pixel position on the top left or top right, or both, of the rectangle may be selected as the reference pixel position at the time of prediction of a motion vector.

Now, in many cases, the contour of a moving object appearing in an image has an inclination that is neither horizontal nor vertical. Accordingly, to more precisely reflect a difference in motion between such a moving object and the background in motion compensation, Non-Patent Literature 2 mentioned below proposes to partition a block at an angle by a boundary determined by a distance ρ from the center point of the block and an angle of inclination θ, as shown in FIG. 34. In the example of FIG. 34, a block BL is partitioned into a first partition PT1 and a second partition PT2 by a boundary BD determined by a distance ρ and an angle of inclination θ. The method of partitioning a block for motion compensation by a boundary having a non-horizontal and non-vertical inclination is called “geometry motion partitioning”. Also, each partition formed by the geometry motion partitioning is called a “geometry partition”.

### CITATION LIST

### Non-Patent Literature

Non-Patent Literature 1: Jungyoup Yang, Kwanghyun Won, Byeungwoo Jeon, “Motion Vector Coding with Optimal PMV Selection” (VCEG-AI22, July 2008)
Non-Patent Literature 2: Qualcomm Inc., “Video coding technology proposal by Qualcomm Inc.” (JCTVC-A121, April 2010)

### SUMMARY OF INVENTION

### Technical Problem

Also in the geometry motion partitioning, a reference pixel position used for prediction of a motion vector is normally the position of any of the corners included in a geometry partition. However, with the method of specifying a distance ρ from the center point of a block and an angle of inclination θ, to recognize a reference pixel position, complex geometric calculation has to be performed to decide the corners included in each geometry partition from the distance ρ and the angle of inclination θ.

Also, according to the Non-Patent Literature 2 mentioned above, the distance ρ is specified on a per pixel basis. Accordingly, when applying the geometry motion partitioning to an oblong block of 16×8 pixels, for example, the range of value of possible distance ρ changes depending on the value of the angle of inclination θ. FIG. 35 shows as an example, with respect to a block of 16×8 pixels, that the range of possible value of ρ is 1 to 4 when the angle of inclination θ is 315° and that the range of possible value of ρ is 1 to 7 when the angle of inclination θ is 0°. That is, in the case of applying the geometry motion partitioning to an oblong block, the search range of the distance ρ has to be dynamically controlled according to the angle of inclination θ in motion estimation.

Any of such aspects of the existing methods results in non-negligible increase in the amount of computation of an encoder and a decoder at the time of using the geometry motion partitioning. Accordingly, the technology according to the present disclosure aims to overcome at least one of the faults described above, and to provide an image processing device and an image processing method capable of using the geometry motion partitioning with less amount of computation compared to the existing methods.

### Solution to Problem

According to an embodiment of the present disclosure, there is provided an image processing device including a motion vector determination section for partitioning a block set in an image into a plurality of partitions using a boundary having an inclination, and determining a motion vector for each partition, and a boundary information generation section for generating boundary information specifying a plurality of points of intersection of a perimeter of the block and the boundary.

The image processing device described above typically can be realized as an image encoding device that encodes an image.

Further, the boundary information may be information specifying each point of intersection of the perimeter of the block and the boundary based on a path along a route around the perimeter from a reference point set on the perimeter.

Further, the boundary information may include information specifying a first point of intersection based on a path from a first reference point, and information specifying a second point of intersection based on a path from a second reference point. The first reference point may be a corner of the block that is selected in advance. And the second reference point may be a corner located next, on the route, after the first point of intersection.

Further, the perimeter may be divided into a plurality of routes. And the information specifying each point of intersection may include information identifying a route to which each point of intersection belongs, and a path along each route from a reference point set on the route.

Further, the motion vector determination section may quantize the path for each point of intersection by a unit quantity larger than one pixel.

Further, the motion vector determination section may set the unit quantity for quantization of the path to be larger as a size of the block is larger.

Further, the perimeter may be divided into four routes each corresponding to a side of the block.

Further, the perimeter may be divided into two routes each including either a top side or a bottom side of the block and either a left side or a right side of the block.

Further, in a case a first point of intersection and a second point of intersection belong to a common route, the boundary information may include information specifying the first point of intersection based on a path from a first reference point which is a starting point of the common route and information specifying the second point of intersection based on a path from a second reference point which is a corner located next on the common route after the first point of intersection.

Further, the image processing device may further include an encoding section for encoding an image and generating an encoded stream, and transmission means for transmitting the encoded stream generated by the encoding section and the boundary information.

Further, according to another embodiment of the present disclosure, there is provided an image processing method for processing an image including partitioning a block set in an image into a plurality of partitions using a boundary having an inclination, and determining a motion vector for each partition which has been partitioned off, and generating boundary information specifying a plurality of points of intersection of a perimeter of the block and the boundary.

Further, according to another embodiment of the present disclosure, there is provided an image processing device including a boundary recognition section for recognizing a boundary which has partitioned a block in an image into a plurality of partitions at a time of encoding of the image, based on boundary information specifying a plurality of points of intersection of a perimeter of the block and the boundary, and a prediction section for predicting a pixel value for each partition which has been partitioned off by the boundary recognized by the boundary recognition section, based on a motion vector.

The image processing device described above typically can be realized as an image decoding device that decodes an image.

Further, the boundary information may be information specifying each point of intersection of the perimeter of the block and the boundary based on a path along a route around the perimeter from a reference point set on the perimeter.

Further, the boundary information may include information specifying a first point of intersection based on a path from a first reference point, and information specifying a second point of intersection based on a path from a second reference point. The first reference point may be a corner of the block that is selected in advance. And the second reference point may be a corner located next, on the route, after the first point of intersection.

Further, the perimeter may be divided into a plurality of routes. And the information specifying each point of intersection may include information indicating a route to which each point of intersection belongs, and a path along each route from a reference point set on the route.

Further, the boundary recognition section inverse may quantize the path for each point of intersection which has been quantized by a unit quantity larger than one pixel.

Further, the boundary recognition section inverse may quantize the path by a unit quantity that is larger as a size of the block is larger.

Further, the perimeter may be divided into four routes each corresponding to a side of the block.

Further the perimeter may be divided into two routes each including either a top side or a bottom side of the block and either a left side or a right side of the block.

Further, in a case a first point of intersection and a second point of intersection belong to a common route, the boundary information may include information specifying the first point of intersection based on a path from a first reference point which is a starting point of the common route and information specifying the second point of intersection based on a path from a second reference point which is a corner located next on the common route after the first point of intersection.

Further, the image processing device may further include a receiving section for receiving an encoded stream which is the image which has been encoded and the boundary information, and a decoding section for decoding the encoded stream received by the receiving section.

Further, according to another embodiment of the present disclosure, there is provided an image processing method for processing an image including recognizing a boundary which has partitioned a block in an image into a plurality of partitions at a time of encoding of the image, based on boundary information specifying a plurality of points of intersection of a perimeter of the block and the boundary, and predicting a pixel value for each partition which has been partitioned off by the recognized boundary, based on a motion vector.

### Advantageous Effects of Invention

According to the image processing device and the image processing method of the present disclosure, the geometry motion partitioning can be used with less amount of computation compared to existing methods.

### BRIEF DESCRIPTION OF DRAWINGS

FIG. 1 is a block diagram showing an example of a configuration of an image encoding device according to an embodiment.

FIG. 2 is a block diagram showing an example of a detailed configuration of a motion estimation section of an image encoding device of an embodiment.

FIG. 3 is a first explanatory diagram for describing partitioning of a block into rectangular partitions.

FIG. 4 is a second explanatory diagram for describing partitioning of a block into rectangular partitions.

FIG. 5 is an explanatory diagram for describing partitioning of a block into non-rectangular partitions.

FIG. 6 is an explanatory diagram for describing a reference pixel position which may be set in a rectangular partition.

FIG. 7 is an explanatory diagram for describing spatial prediction in a rectangular partition.

FIG. 8 is an explanatory diagram for describing temporal prediction in a rectangular partition.

FIG. 9 is an explanatory diagram for describing a multi-reference frame.

FIG. 10 is an explanatory diagram for describing a temporal direct mode.

FIG. 11 is an explanatory diagram for describing a reference pixel position which may be set in a non-rectangular partition.

FIG. 12 is an explanatory diagram for describing spatial prediction in a non-rectangular partition.

FIG. 13 is an explanatory diagram for describing temporal prediction in a non-rectangular partition.

FIG. 14 is an explanatory diagram for describing a route that is set on the perimeter of a block.

FIG. 15 is an explanatory diagram for describing an example of boundary information for a case where the perimeter of a block is not divided.

FIG. 16 is an explanatory diagram for describing a first example of boundary information for a case where the perimeter of a block is divided into two routes.

FIG. 17 is an explanatory diagram for describing a second example of boundary information for a case where the perimeter of a block is divided into two routes.

FIG. 18 is an explanatory diagram for describing an example of boundary information for a case where the perimeter of a block is divided into four routes.

FIG. 19 is an explanatory diagram for describing an example of quantization of boundary information.

FIG. 20 is a flow chart showing an example of a flow of motion estimation process according to an embodiment.

FIG. 21 is a flow chart showing an example of a flow of a boundary information generation process for a case where the perimeter of a block is not divided.

FIG. 22 is a flow chart showing an example of a flow of a boundary information generation process for a case where the perimeter of a block is divided into two routes.

FIG. 23 is a flow chart showing an example of a flow of a boundary information generation process for a case where the perimeter of a block is divided into four routes.

FIG. 24 is a block diagram showing an example of a configuration of an image decoding device according to an embodiment.

FIG. 25 is a block diagram showing an example of a detailed configuration of a motion compensation section of an image decoding device according to an embodiment.

FIG. 26 is a flow chart showing an example of a flow of a motion compensation process according to an embodiment.

FIG. 27 is a flow chart showing an example of a flow of a boundary recognition process for a case where the perimeter of a block is not divided.

FIG. 28 is a flow chart showing an example of a flow of a boundary recognition process for a case where the perimeter of a block is divided into two routes.

FIG. 29 is a flow chart showing an example of a flow of a boundary recognition process for a case where the perimeter of a block is divided into four routes.

FIG. 30 is a block diagram showing an example of a schematic configuration of a television.

FIG. 31 is a block diagram showing an example of a schematic configuration of a mobile phone.

FIG. 32 is a block diagram showing an example of a schematic configuration of a recording/reproduction device.

FIG. 33 is a block diagram showing an example of a schematic configuration of an image capturing device.

FIG. 34 is an explanatory diagram showing an example of conventional geometry motion partitioning where a distance ρ and an angle of inclination θ are specified.

FIG. 35 is an explanatory diagram for describing, with respect to the conventional geometry motion partitioning, the range of the distance ρ which is different according to the angle of inclination θ.

### DESCRIPTION OF EMBODIMENTS

Hereinafter, preferred embodiments of the present disclosure will be described in detail with reference to the appended drawings. Note that, in this specification and the drawings, elements that have substantially the same function and structure are denoted with the same reference signs, and repeated explanation is omitted.

Furthermore, the “Description of Embodiments” will be described in the order mentioned below.

1. Example Configuration of Image Encoding Device According to an Embodiment
1-1. Example of Overall Configuration
1-2. Example Configuration of Motion Estimation Section
1-3. Explanation on Motion Vector Prediction Process
1-4. Example of Boundary Information
1-5. Quantization of Boundary Information

2. Flow of Process at the Time of Encoding According to an Embodiment
2-1. Motion Estimation Process
2-2. Boundary Information Generation Process (No Division of Perimeter)
2-3. Boundary Information Generation Process (Division of Perimeter into Two)
2-4. Boundary Information Generation Process (Division of Perimeter into Four)

3. Example Configuration of Image Decoding Device According to an Embodiment
3-1. Example of Overall Configuration
3-2. Example Configuration of Motion Compensation Section

4. Flow of Process at the Time of Decoding According to an Embodiment
4-1. Motion Compensation Process
4-2. Boundary Recognition Process (No Division of Perimeter)
4-3. Boundary Recognition Process (Division of Perimeter into Two)
4-4. Boundary Recognition Process (Division of Perimeter into Four)

5. Example Application

6. Summary

### 1. Example Configuration of Image Encoding Device According to an Embodiment

[1-1. Example of Overall Configuration]

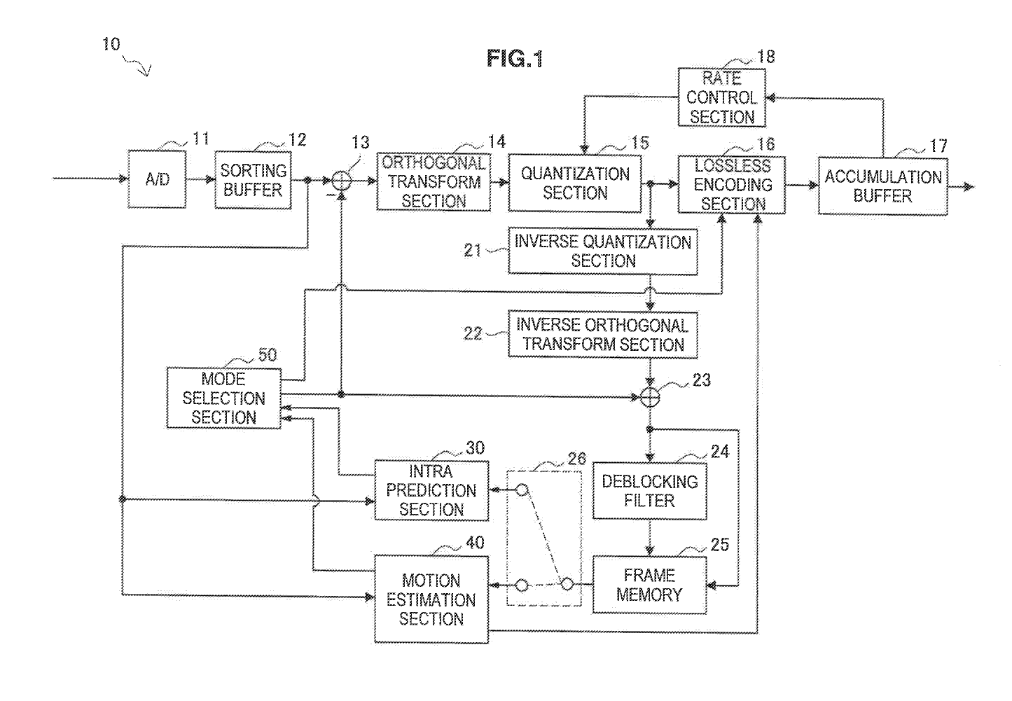

FIG. 1 is a block diagram showing an example of a configuration of an image encoding device 10 according to an embodiment. Referring to FIG. 1, the image encoding device 10 includes an A/D (Analogue to Digital) conversion section 11, a sorting buffer 12, a subtraction section 13, an orthogonal transform section 14, a quantization section 15, a lossless encoding section 16, an accumulation buffer 17, a rate control section 18, an inverse quantization section 21, an inverse orthogonal transform section 22, an addition section 23, a deblocking filter 24, a frame memory 25, a selector 26, an intra prediction section 30, a motion estimation section 40 and a mode selection section 50.

The A/D conversion section 11 converts an image signal input in an analogue format into image data in a digital format, and outputs a series of digital image data to the sorting buffer 12.

The sorting buffer 12 sorts the images included in the series of image data input from the A/D conversion section 11. After sorting the images according to the a GOP (Group of Pictures) structure according to the encoding process, the sorting buffer 12 outputs the image data which has been sorted to the subtraction section 13, the intra prediction section 30 and the motion estimation section 40.

The image data input from the sorting buffer 12 and predicted image data selected by the mode selection section 50 described later are supplied to the subtraction section 13. The subtraction section 13 calculates predicted error data which is a difference between the image data input from the sorting buffer 12 and the predicted image data input from the mode selection section 50, and outputs the calculated predicted error data to the orthogonal transform section 14.

The orthogonal transform section 14 performs orthogonal transform on the predicted error data input from the subtraction section 13. The orthogonal transform to be performed by the orthogonal transform section 14 may be discrete cosine transform (DCT) or Karhunen-Loeve transform, for example. The orthogonal transform section 14 outputs transform coefficient data acquired by the orthogonal transform process to the quantization section 15.

The transform coefficient data input from the orthogonal transform section 14 and a rate control signal from the rate control section 18 described later are supplied to the quantization section 15. The quantization section 15 quantizes the transform coefficient data, and outputs the transform coefficient data which has been quantized (hereinafter, referred to as quantized data) to the lossless encoding section 16 and the inverse quantization section 21. Also, the quantization section 15 switches a quantization parameter (a quantization scale) based on the rate control signal from the rate control section 18 to thereby change the bit rate of the quantized data to be input to the lossless encoding section 16.

The quantized data input from the quantization section 15 and information described later about intra prediction or inter prediction generated by the intra prediction section 30 or the motion estimation section 40 and selected by the mode selection section 50 are supplied to the lossless encoding section 16. The information about intra prediction may include prediction mode information indicating an optimal intra prediction mode for each block, for example. Also, the information about inter prediction may include boundary information for identifying a boundary which has partitioned each block, prediction formula information identifying a prediction formula used for prediction of a motion vector for each partition, difference motion vector information, reference image information and the like, for example.

The lossless encoding section 16 generates an encoded stream by performing a lossless encoding process on the quantized data. The lossless encoding by the lossless encoding section 16 may be variable-length coding or arithmetic coding, for example. Furthermore, the lossless encoding section 16 multiplexes the information about inter prediction or the information about intra prediction mentioned above to the header of the encoded stream (for example, a block header, a slice header or other like). Then, the lossless encoding section 16 outputs the generated encoded stream to the accumulation buffer 17.

The accumulation buffer 17 temporarily stores the encoded stream input from the lossless encoding section 16 using a storage medium, such as a semiconductor memory. Then, the accumulation buffer 17 outputs the accumulated encoded stream at a rate according to the hand of a transmission line (or an output line from the image encoding device 10).

The rate control section 18 monitors the free space of the accumulation buffer 17. Then, the rate control section 18 generates a rate control signal according to the free space on the accumulation buffer 17, and outputs the generated rate control signal to the quantization section 15. For example, when there is not much free space on the accumulation buffer 17, the rate control section 18 generates a rate control signal for lowering the bit rate of the quantized data. Also, for example, when the free space on the accumulation buffer 17 is sufficiently large, the rate control section 18 generates a rate control signal for increasing the bit rate of the quantized data.

The inverse quantization section 21 performs an inverse quantization process on the quantized data input from the quantization section 15. Then, the inverse quantization section 21 outputs transform coefficient data acquired by the inverse quantization process to the inverse orthogonal transform section 22.

The inverse orthogonal transform section 22 performs an inverse orthogonal transform process on the transform coefficient data input from the inverse quantization section 21 to thereby restore the predicted error data. Then, the inverse orthogonal transform section 22 outputs the restored predicted error data to the addition section 23.

The addition section 23 adds the restored predicted error data input from the inverse orthogonal transform section 22 and the predicted image data input from the mode selection section 50 to thereby generate decoded image data. Then, the addition section 23 outputs the generated decoded image data to the deblocking filter 24 and the frame memory 25.

The deblocking filter 24 performs a filtering process for reducing block distortion occurring at the time of encoding of an image. The deblocking filter 24 filters the decoded image data input from the addition section 23 to remove the block distortion, and outputs the decoded image data after filtering to the frame memory 25.

The frame memory 25 stores, using a storage medium, the decoded image data input from the addition section 23 and the decoded image data after filtering input from the deblocking filter 24.

The selector 26 reads, from the frame memory 25, the decoded image data before filtering that is to be used for the intra prediction, and supplies the decoded image data which has been read to the intra prediction section 30 as reference image data. Also, the selector 26 reads, from the frame memory 25, the decoded image data after filtering to be used for the inter prediction, and supplies the decoded image data which has been read to the motion estimation section 40 as reference image data.

The intra prediction section 30 performs an intra prediction process in each intra prediction mode defined by H.264/AVC, based on the encoding target image data that is input from the sorting buffer 12 and the decoded image data supplied via the selector 26. For example, the intra prediction section 30 evaluates the prediction result of each intra prediction mode using a predetermined cost function. Then, the intra prediction section 30 selects an intra prediction mode by which the cost function value is the smallest, that is, an intra prediction mode by which the compression ratio is the highest, as the optimal intra prediction mode. Furthermore, the intra prediction section 30 outputs, to the mode selection section 50, prediction mode information indicating the optimal intra prediction mode, the predicted image data, and the information about intra prediction such as the cost function value. Moreover, the intra prediction section 30 may perform the intra prediction process with a larger block than each intra prediction mode defined by H.264/AVC, based on the encoding target image data input from the sorting buffer 12 and the decoded image data supplied via the selector 26. Also in this case, the intra prediction section 30 evaluates the prediction result of each intra prediction mode using a predetermined cost function, and outputs, to the mode selection section 50, the information about intra prediction for the optimal intra prediction mode.

The motion estimation section 40 performs a motion estimation process with each block set in an image as a target, based on the encoding target image data input from the sorting buffer 12 and the decoded image data as reference image data supplied from frame memory 25.

More specifically, the motion estimation section 40 partitions each block into a plurality of partitions by a plurality of boundary candidates. The boundary candidates for partitioning a block include a boundary having an inclination according to the geometry motion partitioning, in addition to a boundary along a horizontal direction or a vertical direction of H.264/AVC, for example. Further, the motion estimation section 40 calculates a motion vector for each partition based on a pixel value of a reference image and a pixel value of an original image in each partition.

Furthermore, the motion estimation section 40 predicts, for each partition, a motion vector to be used for prediction of a pixel value in an encoding target partition, based on a motion vector already calculated for a block or a partition corresponding to a reference pixel position set for each partition. Prediction of a motion vector may be performed for each of a plurality of prediction formula candidates. A plurality of prediction formula candidates may include a prediction formula that uses spatial correlation, temporal correlation, or both, for example. Accordingly, the motion estimation section 40 predicts a motion vector for each partition for each combination of a boundary candidate and a prediction formula candidate. Then, the motion estimation section 40 selects, as an optimal combination, a combination of a boundary and a prediction formula by which a cost function value according to a predetermined cost function becomes the smallest (i.e., which results in the highest compression ratio).

Such motion estimation process of the motion estimation section 40 will be further described later. The motion estimation section 40 outputs to the mode selection section 50, as the results of the motion estimation process, the information about inter prediction such as boundary information identifying an optimal boundary, prediction formula information identifying an optimal prediction formula, the difference motion vector information, the cost function value and the like, and the predicted image data. Among these, the boundary information is not information specifying the distance ρ from the center point of a block and the angle of inclination θ, but is information specifying two points of intersection of the perimeter of a block and a boundary.

The mode selection section 50 compares the cost function value related to the intra prediction input from the intra prediction section 30 and the cost function value related to the inter prediction input from the motion estimation section 40. Then, the mode selection section 50 selects a prediction method with a smaller cost function value from the intra prediction and the inter prediction. In the case of selecting the intra prediction, the mode selection section 50 outputs the information about intra prediction to the lossless encoding section 16, and also, outputs the predicted image data to the subtraction section 13 and the addition section 23. Also, in the case of selecting the inter prediction, the mode selection section 50 outputs the information about inter prediction described above to the lossless encoding section 16, and also, outputs the predicted image data to the subtraction section 13 and the addition section 23.

[1-2. Example Configuration of Motion Estimation Section]

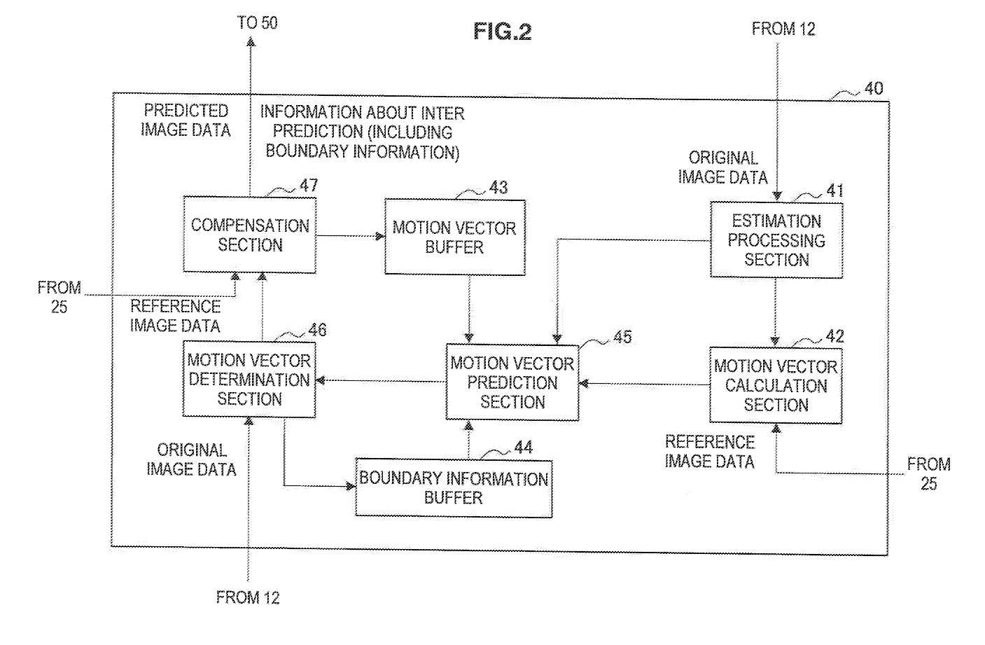

FIG. 2 is a block diagram showing an example of a detailed configuration of the motion estimation section 40 of the image encoding device 10 shown in FIG. 1. Referring to FIG. 2, the motion estimation section 40 includes an estimation processing section 41, a motion vector calculation section 42, a motion vector buffer 43, a boundary information buffer 44, a motion vector prediction section 45, a motion vector determination section 46 and a compensation section 47.

The estimation processing section 41 controls the range of estimation that takes as the target various combinations of boundaries that partition a block set in an image into a plurality of partitions and prediction formulae used for prediction of a motion vector. In the present embodiment, the boundaries to be the target of estimation by the motion estimation section 40 include not only horizontal and vertical boundaries, but also a boundary having an inclination.

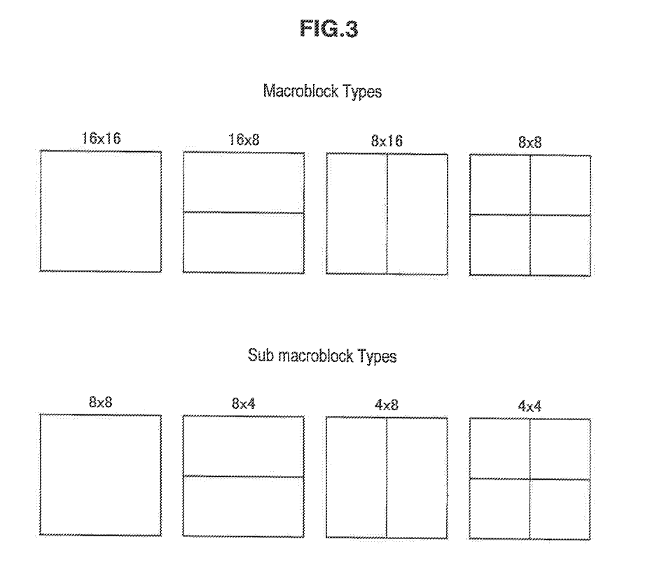

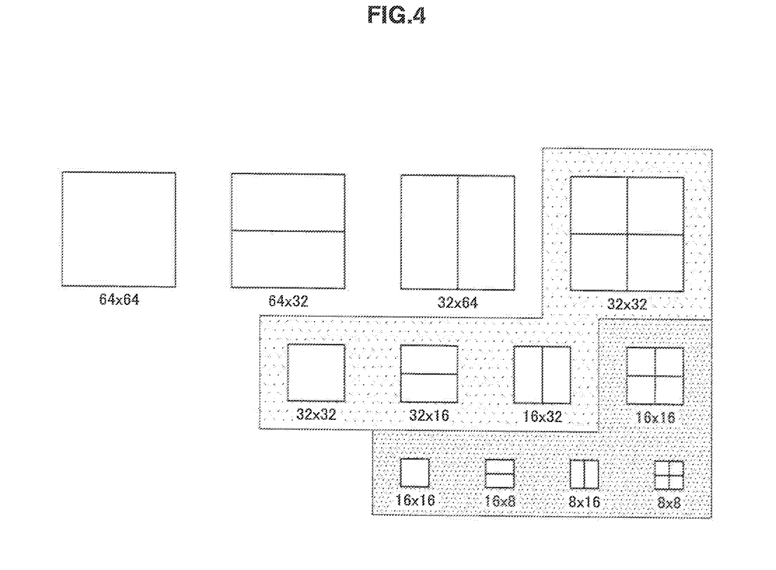

The estimation processing section 41 may partition a block set in an image by a boundary candidate, having no inclination, along the horizontal direction or the vertical direction, as shown in FIGS. 3 and 4, for example. In this case, each partition which has been formed is a rectangular partition. In the example of FIG. 3, a largest macro block of 16×16 pixels may be partitioned into two blocks of 16×8 pixels by a horizontal boundary. Also, a largest macro block of 16×16 pixels may be partitioned into two blocks of 8×16 pixels by a vertical boundary. Furthermore, a largest macro block of 16×16 pixels may be partitioned into four blocks of 8×8 pixels by a horizontal boundary and a vertical boundary. Still further, a macro block of 8×8 pixels may be partitioned into two sub-macro blocks of 8×4 pixels, two sub-macro blocks of 4×8 pixels, or four sub-macro blocks of 4×4 pixels. Also, as shown in FIG. 4, the estimation processing section 41 may partition a block of an extended size (for example, 64×64 pixels), which is larger than a largest macro block of 16×16 pixels supported by H.264/AVC, into rectangular partitions, for example.

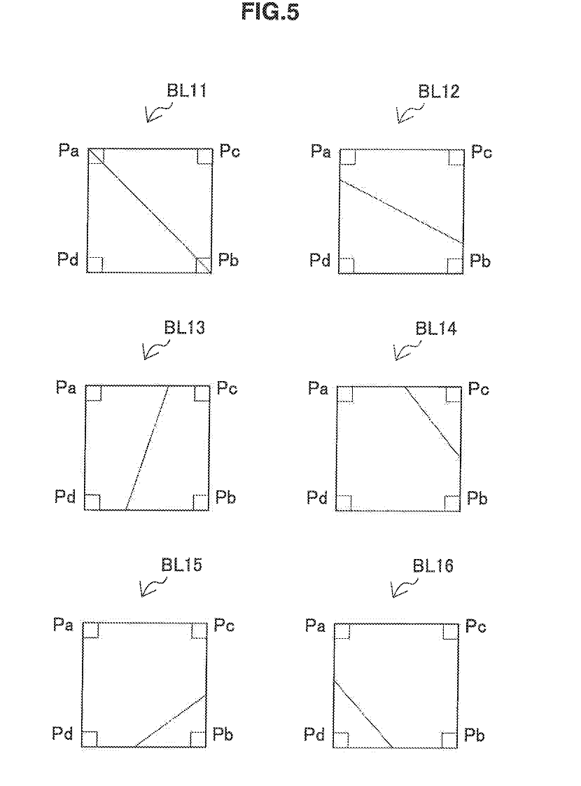

Furthermore, as shown in FIG. 5, the estimation processing section 41 partitions a block set in an image by a boundary candidate having an inclination, for example. In this case, each partition which has been formed may be a non-rectangular partition. In the example of FIG. 5, six types of blocks BL11 to BL16 which are partitioned by boundaries having an inclination are shown. The shapes of geometry partitions formed in the blocks BL11 to BL16 are a triangle, a trapezoid or a pentagon. The estimation processing section 41 sequentially specifies the plurality of boundary candidates while discretely changing each of the positions of two points of intersection of the perimeter of a block and the boundary, for example. Then, the estimation processing section 41 causes a motion vector to be calculated by the motion vector calculation section 42, for each partition which has been partitioned off by a specified boundary. Also, the estimation processing section 41 causes a motion vector to be predicted by the motion vector prediction section 45 using a plurality of prediction formula candidates.

The motion vector calculation section 42 calculates a motion vector for each partition which has been partitioned off by a boundary specified by the estimation processing section 41, based on a pixel value of an original image and a pixel value of a reference image input from the frame memory 25. For example, the motion vector calculation section 42 may interpolate an intermediate pixel value between adjacent pixels by a linear interpolation process and calculate a motion vector with ½-pixel accuracy. Furthermore, the motion vector calculation section 42 may further interpolate an intermediate pixel value by using a six-tap filter and calculate a motion vector with ¼-pixel accuracy, for example. The motion vector calculation section 42 outputs the calculated motion vector to the motion vector prediction section 45.

The motion vector buffer 43 temporarily stores, using a storage medium, a reference motion vector which is referred to in a motion vector prediction process of the motion vector prediction section 45. A motion vector which is referred to in a motion vector prediction process may include a motion vector set for a block or a partition in a reference image which is already encoded, and a motion vector set for another block or partition in an encoding target image.

The boundary information buffer 44 temporarily stores, using a storage medium, boundary information for identifying a reference partition which is referred to in the motion vector prediction process of the motion vector prediction section 45. The boundary information which is stored by the boundary information buffer 44 may include information identifying a boundary which has partitioned a block in a reference image which is already encoded, and information identifying a boundary which has partitioned another block in an encoding target image.

The motion vector prediction section 45 sets a reference pixel position for each partition which has been partitioned off by a boundary specified by the estimation processing section 41. Then, the motion vector prediction section 45 predicts a motion vector to be used for prediction of a pixel value in each partition, based on a motion vector (a reference motion vector) set for a reference partition or a reference block corresponding to the reference pixel position which has been set.

The motion vector prediction section 45 may predict a plurality of motion vectors for one partition using a plurality of prediction formula candidates. For example, a first prediction formula may be a prediction formula that uses a spatial correlation of motion, and a second prediction formula may be a prediction formula that uses a temporal correlation of motion. Also, a prediction formula that uses both the spatial correlation and the temporal correlation of motion may be used as a third prediction formula. In the case of using the spatial correlation of motion, the motion vector prediction section 45 refers to a reference motion vector that is set for another block or partition adjacent to a reference pixel position and stored in the motion vector buffer 43, for example. Also, in the case of using the temporal correlation of motion, the motion vector prediction section 45 refers to a reference motion vector that is set for a block or a partition, co-located with a reference pixel position, in a reference image and stored in the motion vector buffer 43, for example. A prediction formula that may be used by the motion vector prediction section 45 will be further described later by citing an example.

After calculating a predicted motion vector using one prediction formula for one partition, the motion vector prediction section 45 calculates a difference motion vector representing a difference between the motion vector calculated by the motion vector calculation section 42 and the predicted motion vector. Then, the motion vector prediction section 45 associates the information identifying the boundary mentioned above and the prediction formula information identifying the prediction formula mentioned above, and outputs the calculated difference motion vector and the reference image information to the motion vector determination section 46.

The motion vector determination section 46 selects a combination of an optimal boundary and an optimal prediction formula by which the cost function value will be the smallest, using the information input from the motion vector prediction section 45. An optimal boundary for partitioning a block that is set in the image and a motion vector which is to be used for compensation for a pixel value in a partition which has been partitioned off by the boundary are thereby determined. Also, the motion vector determination section 46 generates boundary information, which is described later in detail, for another device that compensates for the pixel value in each partition (typically, an image decoding device). That is, in the present embodiment, the motion vector determination section 46 serves as determination means for determining a motion vector and generation means for generating boundary information. Then, the motion vector determination section 46 outputs, to the compensation section 47, the generated boundary information, the prediction formula information identifying the optimal prediction formula, the corresponding difference motion vector information, the reference image information, the corresponding cost function value and the like.

The compensation section 47 generates predicted image data using the optimal boundary selected by the motion vector determination section 46, the optimal prediction formula, the difference motion vector, and the reference image data input from the frame memory 25. Then, the compensation section 47 outputs, to the mode selection section 50, the generated predicted image data, and the information about inter prediction, input from the motion vector determination section 46, such as the boundary information, the prediction formula information, the difference motion vector information, the cost function value and the like. Also, the compensation section 47 causes the motion vector buffer 43 to store the motion vector used for the generation of the predicted image data, that is, the motion vector that is finally set for each partition.

[1-3. Explanation on Motion Vector Prediction Process]

Next, the motion vector prediction process of the motion vector prediction section 45 described above will be more specifically described.

(1) Prediction of Motion Vector in Rectangular Partition

(1-1) Reference Pixel Position

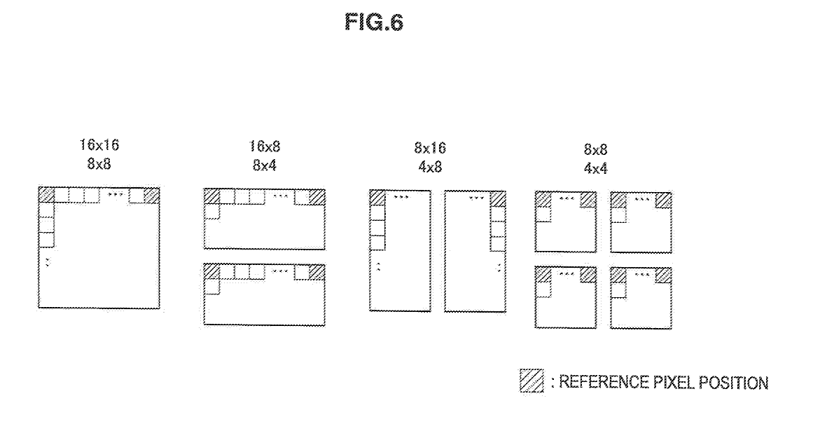

FIG. 6 is an explanatory diagram for describing a reference pixel position which may be set in a rectangular partition. Referring to FIG. 6, a rectangular block (16×16 pixels) not partitioned by a boundary, and rectangular partitions each partitioned by a horizontal or vertical boundary are shown. The motion vector prediction section 45 uniformly sets, for these rectangular partitions, reference pixel position(s) for prediction of a motion vector at the top left, the top right, or both in each partition. In FIG. 6, these reference pixel positions are shown by diagonal shades. Additionally, in 11.264/AVC, a reference pixel position in a partition of 8×16 pixels is set at the top left for a partition which is on the left side in the block, and at the top right for a partition on the right side in the block.

(1-2) Spatial Prediction

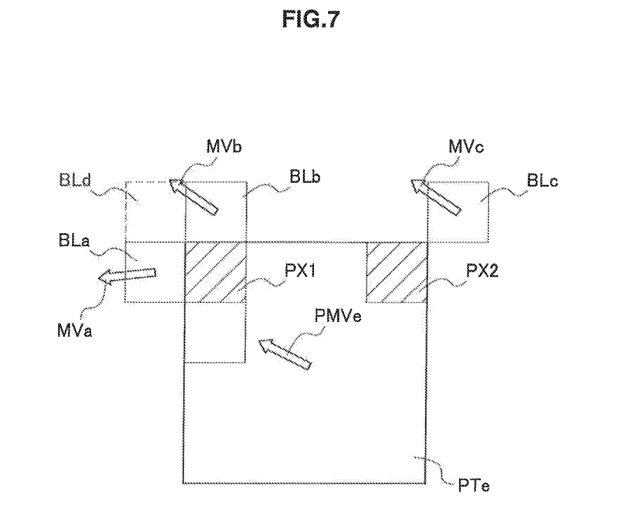

FIG. 7 is an explanatory diagram for describing spatial prediction in a rectangular partition. Referring to FIG. 7, two reference pixel positions, PX1 and PX2, which may be set in one rectangular partition PTe are shown. A prediction formula that uses spatial correlation of motion has, as inputs, motion vectors set for other blocks or partitions adjacent to these reference pixel positions PX1 and PX2. Additionally, in the present specification, the term “adjacent” includes not only a case where two blocks, partitions or pixels share a side, but also a case where a vertex is shared.

For example, a motion vector set for a block BLa to which a pixel at the left of the reference pixel position PX1 belongs is taken as MVa. Also, a motion vector set for a block BLb to which a pixel above the reference pixel position PX1 belongs is taken as MVb. Further, a motion vector set for a block BLc to which a pixel at the top right of the reference pixel position PX2 belongs is taken as MVc. These motion vectors MVa, MVb and MVc are already encoded. A predicted motion vector PMVe for the rectangular partition PTe in the encoding target block may be calculated from the motion vectors MVa, MVb and MVc using a prediction formula as follows.

[Math. 1]

PMVe=med(MVa,MVb,MVc) (I)

Here, med in formula (1) represents a median operation. That is, according to formula (1), the predicted motion vector PMVe is a vector that takes a median value of a horizontal component and a median value of a vertical component, of the motion vectors MVa, MVb and MVc, as the components. Additionally, formula (1) described above is merely an example of a prediction formula that uses spatial correlation. For example, in the case any of the motion vectors MVa, MVb and MVc does not exist because an encoding target block is located at an end portion of an image, the non-existent motion vector may be omitted from the arguments of the median operation. Also, for example, in the case an encoding target block is located at the right end of an image, a motion vector set for a block BLd shown in FIG. 7 may be used instead of the motion vector MVc.

Additionally, the predicted motion vector PMVe is also referred to as a predictor. Particularly, a predicted motion vector calculated by the prediction formula that uses spatial correlation of motion, as the formula (1), is referred to as a spatial predictor. On the other hand, a predicted motion vector that is calculated by a prediction formula that uses temporal correlation of motion that is described in the following section is referred to as a temporal predictor.

After determining the predicted motion vector PMVe in this manner, the motion vector prediction section 45 calculates a difference motion vector MVDe representing the difference between the motion vector MVe calculated by the motion vector calculation section 42 and the predicted motion vector PMVe in the manner of the following formula.

[Math. 2]

MVDe=MVe−PMVe (2)

The difference motion vector information that is output from the motion estimation section 40 as one piece of the information about inter prediction represents the difference motion vector MVDe. The difference motion vector information may be encoded by the lossless encoding section 16, and transmitted to a device for decoding images.

(1-3) Temporal Prediction

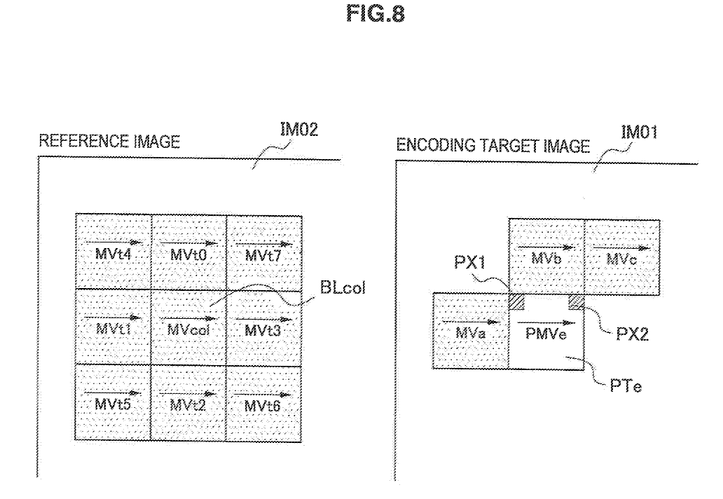

FIG. 8 is an explanatory diagram for describing temporal prediction in a rectangular partition. Referring to FIG. 8, an encoding target image IM01 including an encoding target partition PTe, and a reference image IM02 are shown. A block BLcol in the reference image IM02 is a so-called co-located block that includes a pixel at a common position, in the reference image IM02, as the reference pixel position PX1 or PX2. The prediction formula that uses temporal correlation of motion has, as an input, a motion vector set for the co-located block BLcol or a block (or a partition) adjacent to the co-located block BLcol.

For example, a motion vector set for the co-located block BLcol is taken as MVcol. Also, motion vectors set for blocks above, left, below, right, top left, bottom left, bottom right and top right of the co-located block BLcol are taken, respectively, as MVt0 to MVt7. These motion vectors MVcol and MVt0 to MVt7 are already encoded, in this case, the predicted motion vector PMVe may be calculated from the motion vectors MVcol and MVt0 to MVt7 using the following prediction formula (3) or (4).

[Math. 3]

PMVe=med(MVcol,MCt1, . . . , MVt3) (3)

PMVe=med(MVcol,MVt1, . . . , MVt7) (4)

Also, a prediction formula as below that uses both the spatial correlation and the temporal correlation of motion may also be used. Additionally, the motion vectors MVa, MVb and MVc are motion vectors set for blocks adjacent to the reference pixel position PX1 or PX2.

[Math. 4]

PMVe=med(MVcol,MVcol,MVa,MVb,MVc) (5)

Also in this case, the motion vector prediction section 45 calculates a difference motion vector MVDe representing the difference between a motion vector MVe calculated by the motion vector calculation section 42 and a predicted motion vector PMVe after determining the predicted motion vector PMVe. Then, difference motion vector information representing a difference motion vector MVDe related to the optimal combination of a boundary and a prediction formula may be output from the motion estimation section 40 and encoded by the lossless encoding section 16.

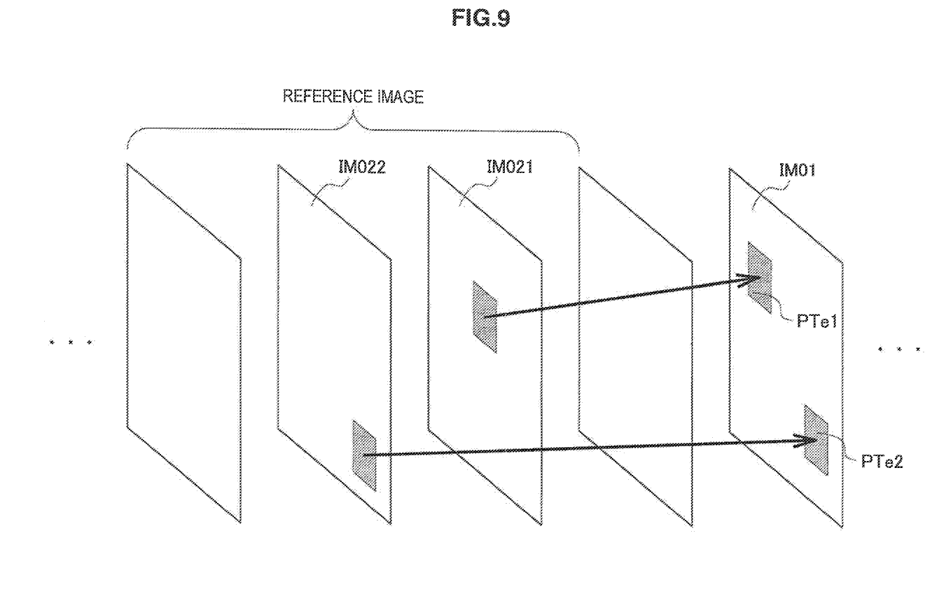

Additionally, in the example of FIG. 8, only one reference image IM02 is shown for one encoding target image IM01, but a different reference image may be used for each partition in one encoding target image IM01. In the example of FIG. 9, a reference image that is referred to at the time of prediction of a motion vector of a partition PTe1 in an encoding target image IM01 is IM021, and a reference image that is referred to at the time of prediction of a motion vector of a partition PTe2 is IM022. Such a method for setting a reference image is called a multi-reference frame.

(2) Direct Mode

Additionally, to prevent lowering of the compression ratio in accordance with the increase in the amount of information of the motion vector information, H.264/AVC introduces a so-called direct mode mainly for a B picture. In the direct mode, the motion vector information is not encoded, and motion vector information of an encoding target block is generated from motion vector information of a block which is already encoded. The direct mode includes a spatial direct mode and a temporal direct mode, and it is possible to switch between these two modes depending on a slice, for example. Such direct mode may be used also in the present embodiment.

For example, in the spatial direct mode, a motion vector MVe for an encoding target partition may be determined using prediction formula (1) described above, in the manner of the following formula.

[Math. 5]

MVe=PMVe (6)

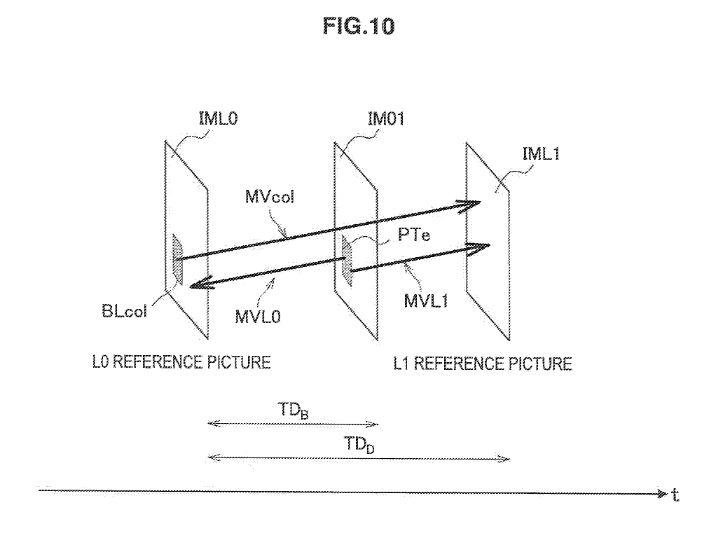

FIG. 10 is an explanatory diagram for describing the temporal direct mode. In FIG. 10, a reference image IML0 which is an L0 reference picture of an encoding target image IM01, and a reference image IML1 which is an L1 reference picture of the encoding target image IM01 are shown. A block BLcol in the reference image IML0 is a co-located block of an encoding target partition PTe in the encoding target image IM01. Here, a motion vector set for the co-located block BLcol is taken as MVcol. Also, a distance on a time axis between the encoding target image IM01 and the reference image IML0 is taken as TD_{B}, and a distance on a time axis between the reference image IML0 and the reference image IML1 is taken as TD_{D}. Then, in the temporal direct mode, motion vectors MVL0 and MVL1 for the encoding target partition PTe may be determined in the manner of the following formula.

$$\begin{matrix}[ Math . 6 ] & \\ MVL 0 = \frac{{TD}_{B}}{{TD}_{D}} MVcol & ( 7 ) \\ MVL 1 = \frac{{TD}_{D} - {TD}_{B}}{{TD}_{D}} MVcol & ( 8 )\end{matrix}$$

Additionally, as an index for expressing a distance on a time axis, a POC (Picture Order Count) may be used. The use/non-use of such direct mode may be specified on a block-by-block basis, for example.

(3) Prediction of Motion Vector in Non-Rectangular Partition

As described above, reference pixel positions may be uniformly defined for rectangular partitions, in the manner of a pixel on the top left or the top right, for example. In contrast, in the case a block is partitioned by a boundary having an inclination as in the case of the geometry motion partition, since the shapes of non-rectangular partitions that are formed are various, it is desirable that a reference pixel position is adaptively set.

(3-1) Reference Pixel Position

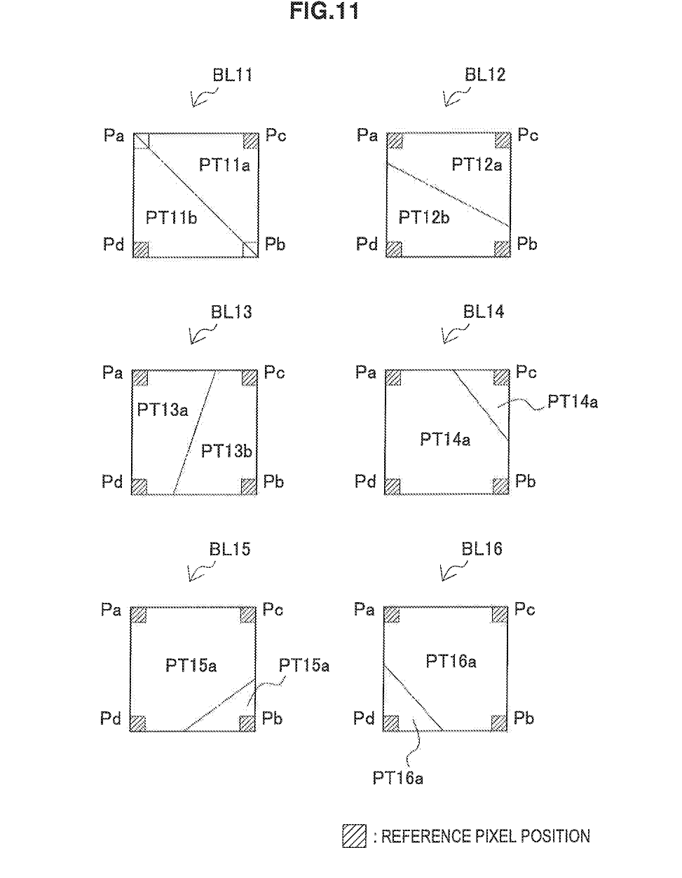

FIG. 11 is an explanatory diagram for describing a reference pixel position which may be set in a non-rectangular partition. The six blocks BL11 to BL16 shown in FIG. 5 are again shown in FIG. 11. If a boundary is a straight line, each partition formed in the block includes at least one pixel located at a corner of the block. Accordingly, the position of the pixel at the corner may be the reference pixel position. In the example of FIG. 11, the reference pixel position of a partition PT11a of the block BL11 may be set to the position of a pixel Pc. The reference pixel position of a partition PT1b of the block BL11 may be set to the position of a pixel Pd. Likewise, the reference pixel position of a partition PT12a of the block BL12 may be set to the position of one or both of pixels Pa and Pc. The reference pixel position of each partition of other blocks may be set in the same manner.

(3-2) Spatial Prediction

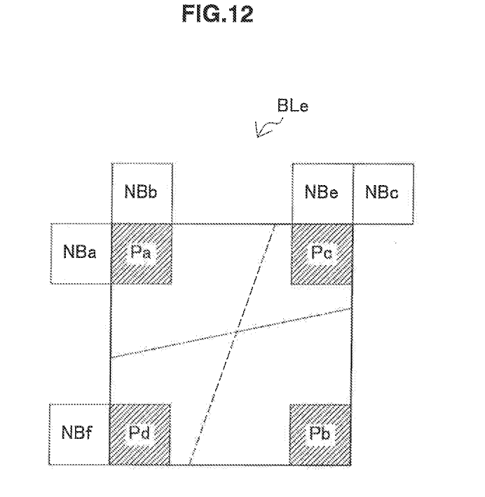

FIG. 12 is an explanatory diagram for describing spatial prediction in a non-rectangular partition. Referring to FIG. 12, four pixel positions Pa to Pd which may be set as the reference pixel positions of respective partitions of an encoding target block BLe are shown. Also, blocks NBa and NBb are adjacent to the pixel position Pa. Blocks NBc and NBe are adjacent to the pixel position Pc. A block NBf is adjacent to the pixel position Pd. A prediction formula that uses spatial correlation of motion in relation to a non-rectangular partition may be a prediction formula that takes, as inputs, motion vectors set for adjacent blocks (or partitions) NBa to NBf adjacent to the reference pixel positions Pa to Pd, for example.

Formulae (9) and (10) are each an example of a prediction formula for predicting a predicted motion vector PMVe for a partition whose reference pixel position is at the top left corner (the pixel position Pa). Additionally, a motion vector MVni (i==a, b, . . . , f) represents a motion vector set for an adjacent block NBi.

[Math. 7]

PMVe=MVna (9)

PMVe=MVnb (10)

Formulae (9) and (10) are examples of the simplest prediction formula. However, other formulae may also be used as the prediction formula. For example, in the case a partition includes both the top left and top right corners, a prediction formula based on motion vectors set for adjacent blocks NBa, NBb and NBc may be used, as with the spatial prediction for a rectangular partition described using FIG. 7. The prediction formula for this case is the same as formula (1).

Additionally, for a partition whose reference pixel position is at the bottom right corner (the pixel position Pb), a motion vector set for an adjacent block (or partition) cannot be used because the adjacent block is not yet encoded. In this case, the motion vector prediction section 45 may set the predicted motion vector based on the spatial correlation to a zero vector.

(3-3) Temporal Prediction

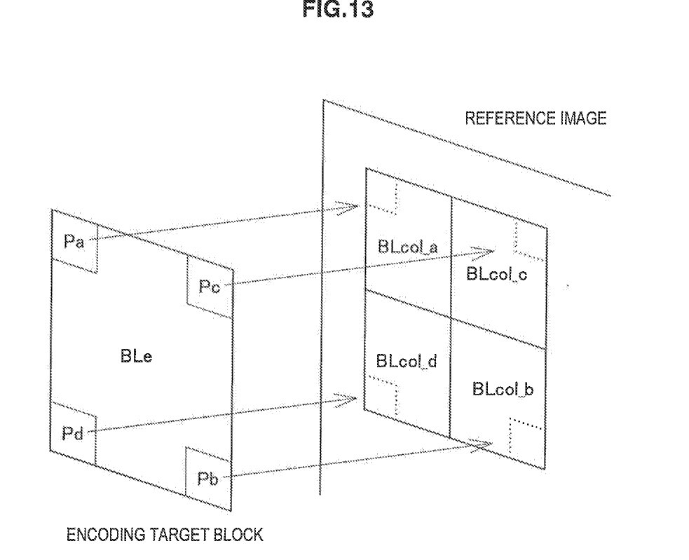

FIG. 13 is an explanatory diagram for describing temporal prediction in a non-rectangular partition. Referring to FIG. 13, four pixel positions Pa to Pd which may be set as reference pixel positions of respective partitions in an encoding target block BLe are shown. In the case the reference pixel position is the pixel position Pa, the co-located block in a reference image is a block BLcol_a. In the case the reference pixel position is the pixel position Pb, the co-located block in the reference image is a block BLcol_. In the case the reference pixel position is the pixel position Pc, the co-located block in the reference image is a block BLcol_c. In the case the reference pixel position is the pixel position Pd, the co-located block in the reference image is a block BLcol_d. The motion vector prediction section 45 recognizes a co-located block (or a co-located partition) BLcol in this manner according to the reference pixel position described above. Also, as described using FIG. 8, the motion vector prediction section 45 further recognizes a block or a partition adjacent to the co-located block (or the co-located partition) BLcol, for example. Then, the motion vector prediction section 45 can calculate a predicted motion vector using the motion vectors MVcol and MVt0 to MVt7 (see FIG. 8) set in the blocks or the partitions in the reference image corresponding to the reference pixel positions and according to the prediction formula that uses temporal correlation of motion. The prediction formula for this case may be the same as the formula (3) or (4), for example.

(3-4) Temporal/Spatial Prediction

Furthermore, the motion vector prediction section 45 may use a prediction formula that uses both the spatial correlation and the temporal correlation of motion, also for a non-rectangular partition. In such a case, the motion vector prediction section 45 can use a prediction formula that is based on a motion vector set for an adjacent block (or an adjacent partition) described using FIG. 12 and a motion vector set for a co-located block (or a co-located partition) in a reference image described using FIG. 13. The prediction formula for this case may be the same as formula (5), for example.

(4) Selection of Prediction Formula

As described above, the motion vector prediction section 45 may use as the prediction formula candidates, at the time of prediction of a motion vector (calculation of a predicted motion vector), a prediction formula that uses spatial correlation, a prediction formula that uses temporal correlation, and a prediction formula that uses temporal/spatial correlation. Also, the motion vector prediction section 45 may use a plurality of prediction formula candidates as the prediction formula that uses temporal correlation, for example. The motion vector prediction section 45 calculates a predicted motion vector for each partition in this manner for each of a plurality of boundary candidates specified by the estimation processing section 41 and for each of a plurality of prediction formula candidates. Then, the motion vector determination section 46 evaluates each combination of a boundary candidate and a prediction formula candidate based on a cost function value, and selects an optimal combination with the highest compression ratio (that achieves the highest encoding efficiency). As a result, a boundary that partitions a block is changed for each block set in an image, for example, and a prediction formula applied to the block can be adaptively switched.

[1-4. Example of Boundary Information]

In the present embodiment, the boundary information that is output by the motion vector determination section 46 is not information specifying the distance ρ from the center point of a block and the angle of inclination θ, but information specifying a plurality of points of intersection of the perimeter of a block and a boundary. More specifically, for example, the boundary information may be information specifying each point of intersection of the perimeter of a block and the boundary based on a path along the route around the perimeter from a reference point set on the perimeter. In the present embodiment, a reference point on the route is a starting point (or an origin point) at the time of measuring the path along the route. In the case the perimeter of a block is divided into a plurality of routes, one reference point is set for each route. However, the positions of a plurality of reference points may overlap one another. Additionally, in the present embodiment, a reference point that is fixedly set without depending on the position of the point of intersection of the perimeter of a block and the boundary is referred to as a fixed reference point. On the other hand, a reference point that is dynamically set depending on the position of the point of intersection is referred to as a variable reference point.

(1) Example Configuration of Route on Perimeter

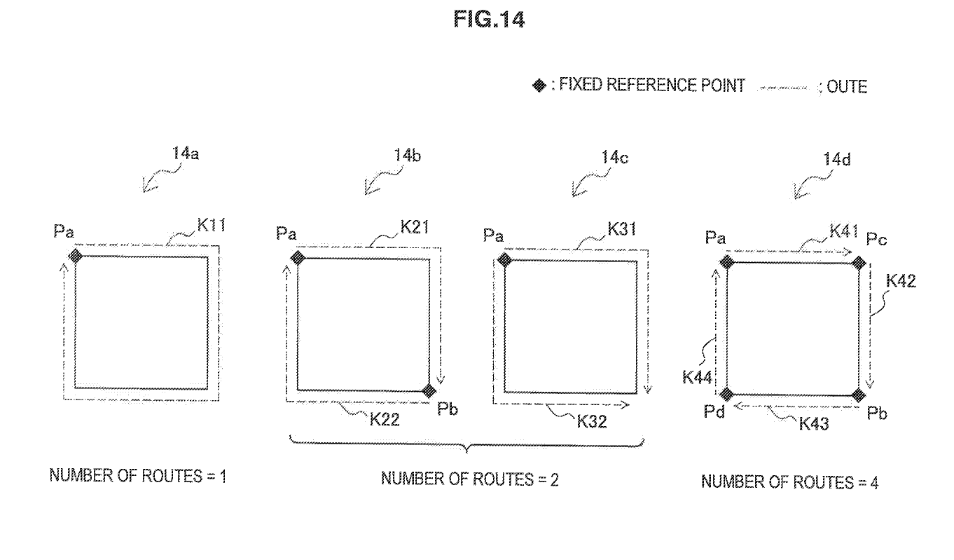

FIG. 14 is an explanatory diagram for describing a route on the perimeter of a block. Referring to FIG. 14, example configurations 14a to 14d of four typical types of routes are shown.

In the first example configuration 14a, a top left corner Pa is set as the fixed reference point. Also, one route K11 going around the perimeter of the block in a clockwise manner with the reference point Pa as the starting point is configured. The length of the route K11 is equal to the total length of the perimeter of the block.

In the second example configuration 14b, a top left corner Pa and a bottom right corner Pb are set as the fixed reference points. Also, a route K21 going half way around the perimeter of the block in a clockwise manner with the reference point Pa as the starting point, and a route K22 going half way around the perimeter of the block in a clockwise manner with the reference point Pb as the starting point are configured. That is, in the second example configuration 14b, the perimeter of the block is divided into two routes. The lengths of the routes K21 and 3K22 are equal to half the length of the perimeter of the block.

In the third example configuration 14c, a top left corner Pa is set as the fixed reference point. Also, a route K31 going half way around the perimeter of the block in a clockwise manner with the reference point Pa as the starting point, and a route K32 going half way around the perimeter of the block in an anticlockwise manner with the reference point Pa as the starting point are configured. That is, also in the third example configuration 14c, the perimeter of the block is divided into two routes. The lengths of the routes K31 and K32 are equal to half the length of the perimeter of the block.

In the fourth example configuration 14d, four corners Pa, Pc, Pb and Pd are set as the fixed reference points. Also, a route K141 along the top side of the block with the reference point Pa as the starting point, a route K42 along the right side of the block with the reference point Pc as the starting point, a route K43 along the bottom side of the block with the reference point Pb as the starting point, and a route K44 along the left side of the block with the reference point Pd as the starting point are configured. That is, in the fourth example configuration 14d, the perimeter of the block is divided into four routes. The lengths of the routes K41, K42, K43 and K44 are equal to the lengths of the corresponding sides of the block.

Additionally, the configuration of the route on the perimeter of a block is not limited to such examples. For example, a route having a different reference point from the example configuration shown in FIG. 14, a route going around in a different direction, or a route divided in a different pattern may be configured.

(2) Example of Boundary Information (No Division of Perimeter)

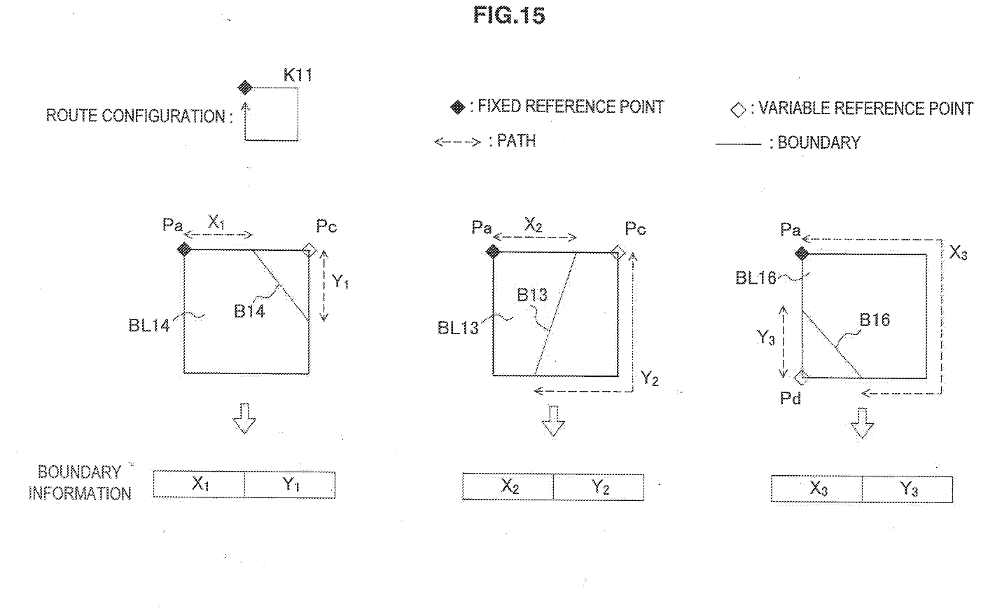

FIG. 15 is an explanatory diagram for describing an example of boundary information which may be generated by the motion vector determination section 46 in the first example configuration 14a in FIG. 14. As can be seen from FIG. 15, in the first example configuration 14a, the boundary information includes information specifying a first point of intersection closer to the reference point Pa and information specifying a second point of intersection farther away from the reference point Pa in this order. Of the two, the first point of intersection is specified based on the path from the fixed reference point Pa. On the other hand, the second point of intersection is specified taking the corner located next after the first point of intersection on the route K11 as the reference point (the variable reference point) and based on the path from this reference point.

In the example on the left in FIG. 15, a first point of intersection of the perimeter of a block BL14 and a boundary B14 is specified by a path X₁ from the reference point Pa to the first point of intersection. Also, the corner located next after the first point of intersection on the route K11 is a corner Pc. Accordingly, a second point of intersection is specified by a path Y₁ from the variable reference point Pc to the second point of intersection. Of the two, the path X₁ is included in the first half of the boundary information, and the path Y₁ is included in the second half thereof.

In the example in the middle in FIG. 15, a first point of intersection of the perimeter of a block BL13 and a boundary B13 is specified by a path X₂ from the reference point Pa to the first point of intersection. Also, the corner located next after the first point of intersection on the route K11 is a corner Pc. Accordingly, a second point of intersection is specified by a path Y₂ from the variable reference point Pc to the second point of intersection. Of the two, the path X₂ is included in the first half of the boundary information, and the path Y₂ is included in the second half thereof.

In the example on the right in FIG. 15, a first point of intersection of the perimeter of a block BL16 and a boundary B16 is specified by a path. X₃ from the reference point Pa to the first point of intersection. Also, the corner located next after the first point of intersection on the route K11 is a corner Pd. Accordingly, a second point of intersection is specified by a path Y₃ from the variable reference point Pd to the second point of intersection. Of the two, the path X₃ is included in the first half of the boundary information, and the path Y₃ is included in the second half thereof.

Generally, two points of intersection of the perimeter of a block and a boundary partitioning the block are not located on the same side of the block. Therefore, as in the example of FIG. 15, by encoding the first point of intersection closer to a reference point that is selected in advance, and then, taking the corner located next after the first point of intersection as the reference point (the variable reference point) for the second point of intersection to be encoded later, the dynamic range of the path of the second point of intersection is made small. As a result, the bit rate of the boundary information regarding the second point of intersection after variable-length coding may be reduced compared to when specifying the second point of intersection based on the path from the fixed reference point.

(3) Example of Boundary Information (Division of Perimeter into Two)

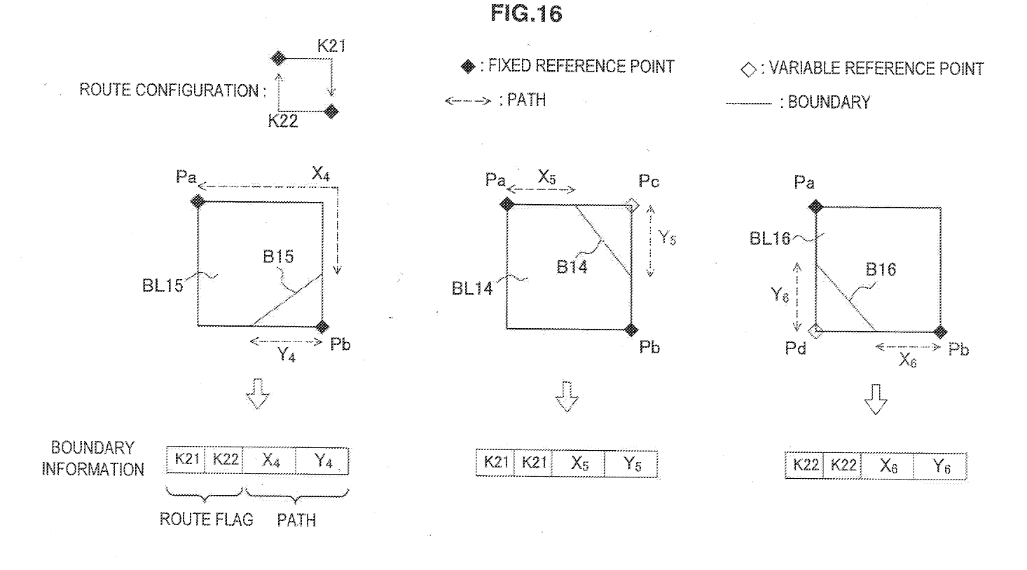

FIG. 16 is an explanatory diagram for describing an example of boundary information which may be generated by the motion vector determination section 46 in the second example configuration 14b in FIG. 14. As can be seen from FIG. 16, in the second example configuration 14b, the boundary information includes information identifying a route to which each point of intersection belongs (for example, a route flag) and a path along a route from a reference point set on this route. Also, in the case two points of intersection belong to a common route, a second point of intersection located farther away from the fixed reference point is specified based on the path from a variable reference point.

In the example on the left in FIG. 16, a first point of intersection belongs to a route K21, and a second point of intersection belongs to a route K22. The first point of intersection of the perimeter of a block BL15 and a boundary B15 is specified by a path X₄ along the route K21 from a reference point Pa to the first point of intersection. Also, the second point of intersection is specified by a path Y₄ along the route K22 from a reference point Pb to the second point of intersection. In this case, information about either point of intersection may be encoded first. However, pieces of information identifying the routes regarding the two points of intersection are encoded before the paths regarding the two points of intersection.

In the example in the middle in FIG. 16, two points of intersection both belong to the route K21. Among these, a first point of intersection located closer to the fixed reference point Pa on the route K21 is specified by a path X₅ from the fixed reference point Pa to the first point of intersection. Also, the corner located next after the first point of intersection on the route K21 is a corner Pc. Accordingly, the second point of intersection is specified by a path Y₅ from the variable reference point Pc to the second point of intersection. Moreover, pieces of information identifying the routes to which the two points of intersection belong (K21, K21) are included in the first half of the boundary information in this order, and the path of the first point of intersection (X₅) and the path of the second point of intersection (Y₅) are included in the second half thereof in this order.

In the example on the right in FIG. 16, two points of intersection both belong to the route K22. Of the two, a first point of intersection located closer to a fixed reference point Pb on the route K22 is specified by a path X from the fixed reference point Pb to the first point of intersection. Also, the corner located next after the first point of intersection on the route K22 is a corner Pd. Accordingly, the second point of intersection is specified by a path Y₆ from the variable reference point Pd to the second point of intersection. Moreover, pieces of information identifying the routes to which the two points of intersection belong (K22, K22) are included in the first half of the boundary information in this order, and the path of the first point of intersection (X₆) and the path of the second point of intersection (Y₆) are included in the second half thereof in this order.

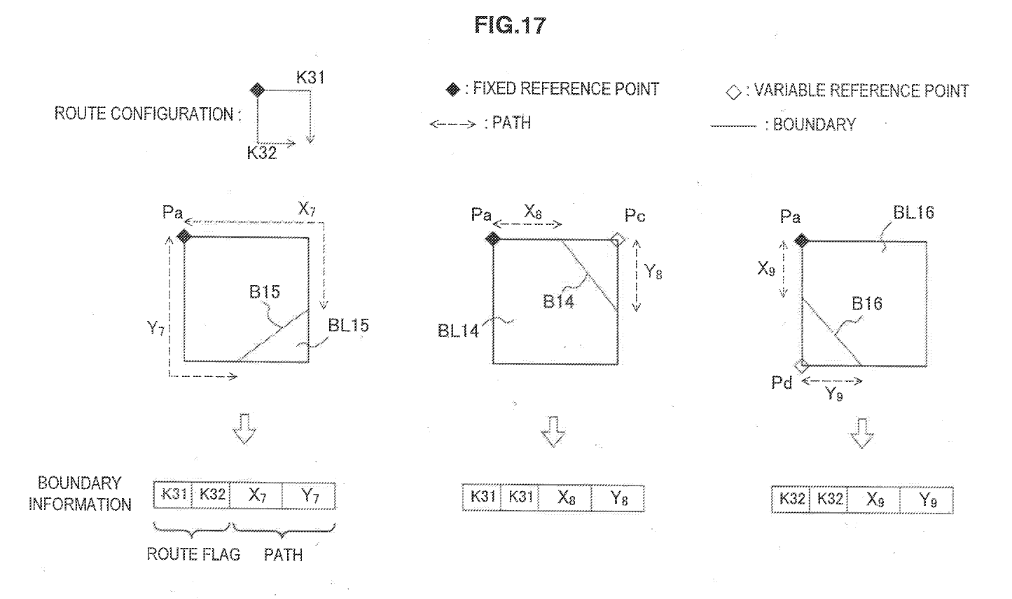

FIG. 17 is an explanatory diagram for describing an example of boundary information which may be generated by the motion vector determination section 46 in the third example configuration 14c in FIG. 14. Also in the third example configuration 14c, the boundary information includes information identifying a route to which each point of intersection belongs and a path along a route from a reference point set on this route. Also, in the case two points of intersection belong to a common route, a second point of intersection located farther away from the fixed reference point is specified based on the path from a variable reference point.

In the example on the left in FIG. 17, a first point of intersection belongs to a route K31, and a second point of intersection belongs to a route K32. The first point of intersection of the perimeter of a block BL15 and a boundary B15 is specified by a path X₇ along the route K31 from a reference point Pa to the first point of intersection. Also, the second point of intersection is specified by a path Y₇ along the route K32 from the reference point Pa to the second point of intersection. In this case, information about either point of intersection may be encoded first. However, pieces of information identifying the routes regarding the two points of intersection are encoded before the paths regarding the two points of intersection.

In the example in the middle in FIG. 17, two points of intersection both belong to the route K31. Of the two, a first point of intersection located closer to the fixed reference point Pa on the route K31 is specified by a path X₈ from the fixed reference point Pa to the first point of intersection. Also, the corner located next after the first point of intersection on the route K31 is a corner Pc. Accordingly, the second point of intersection is specified by a path Y₈ from the variable reference point Pc to the second point of intersection. Moreover, pieces of information identifying the routes to which the two points of intersection belong (K31, K31) are included in the first half of the boundary information in this order, and the path of the first point of intersection (X₈) and the path of the second point of intersection (Y₈) are included in the second half thereof in this order.

In the example on the right in FIG. 17, two points of intersection both belong to the route K32. Of the two, a first point of intersection located closer to a fixed reference point Pa on the route 22 is specified by a path X₉ from the fixed reference point Pa to the first point of intersection. Also, the corner located next after the first point of intersection on the route K32 is a corner Pd. Accordingly, the second point of intersection is specified by a path Y₉ from the variable reference point Pd to the second point of intersection. Moreover, pieces of information identifying the routes to which the two points of intersection belong (K32, K32) are included in the first half of the boundary information in this order, and the path of the first point of intersection (X₉) and the path of the second point of intersection (Y₉) are included in the second half thereof in this order.

In the examples of FIGS. 16 and 17, since the perimeter of a block is divided into two routes, a route to which one point of intersection belongs can be identified by one bit. Also, the dynamic range of path from a reference point to a point of intersection is half that of the example of FIG. 15. With the variable-length coding, normally, a shorter code is assigned to a shorter value. As a result, in the examples of FIGS. 16 and 17, the overall bit rate of the boundary information may be reduced compared to the example of FIG. 15. Also, by specifying the second point of intersection based on a path from a variable reference point, the bit rate of the boundary information regarding the second point of intersection can be further reduced, as with the example of FIG. 15.

(4) Example of Boundary Information (Division of Perimeter into Four)

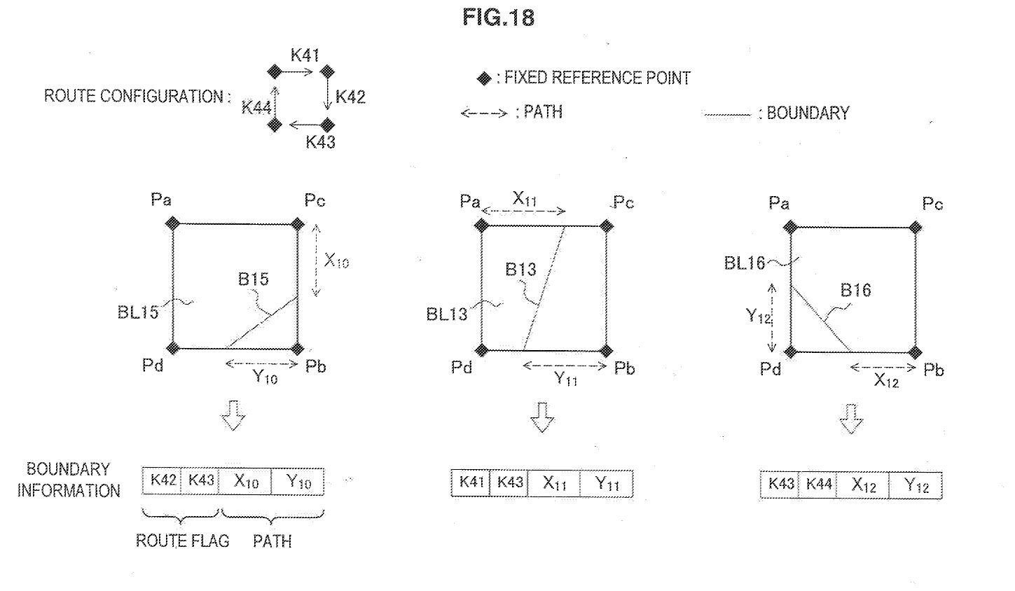

FIG. 18 is an explanatory diagram for describing an example of boundary information which may be generated by the motion vector determination section 46 in the fourth example configuration 14d in FIG. 14. Also in the fourth example configuration 14d, the boundary information includes information identifying a route to which each point of intersection belongs and a path along a route from a reference point set on this route.

In the example on the left in FIG. 18, a first point of intersection belongs to a route K42, and a second point of intersection belongs to a route K43. The first point of intersection is specified by a path X₁₀ along the route K42 from a reference point Pc to the first point of intersection. Also, the second point of intersection is specified by a path Y₁₀ along the route K43 from a reference point Pb to the second point of intersection.

In the example in the middle in FIG. 18, a first point of intersection belongs to a route K41, and a second point of intersection belongs to a route K43. The first point of intersection is specified by a path X₁₁ along the route K41 from a reference point Pa to the first point of intersection. Also, the second point of intersection is specified by a path Y₁₁ along the route K43 from a reference point Pb to the second point of intersection.

In the example on the right in FIG. 18, a first point of intersection belongs to a route K43, and a second point of intersection belongs to a route K44. The first point of intersection is specified by a path X₁₂ along the route K43 from a reference point Pb to the first point of intersection. Also, the second point of intersection is specified by a path Y₁₂ along the route K44 from a reference point Pd to the second point of intersection.

In the example of FIG. 18, since the perimeter of a block is divided into four routes, a route to which one point of intersection belongs can be identified by two bits. Also, the dynamic range of a path from a reference point to a point of intersection is one fourth compared to the example of FIG. 15, and half that of the examples of FIGS. 16 and 17. As a result, in the example of FIG. 18, the bit rate of the overall boundary information may further be reduced.

[1-5. Quantization of Boundary Information]

The granularity of specification of a path regarding each point of intersection included in the boundary information described above may be determined generally taking into account the quality of motion compensation, the bit rate, the processing cost of motion estimation and the like. For example, if the granularity of specification of a path is increased, a boundary close to the actual contour of a moving object is more likely to be specified, and thus, the quality of motion compensation may be increased. However, in this case, the bit rate of the boundary information is increased. Also, since the estimation range for the motion estimation is widened, the processing cost also possibly increases. In contrast, if the granularity of specification of a path is decreased, although the quality of motion compensation may be reduced, the bit rate of the boundary information will also be reduced. Particularly, a large block size may be selected when a motion appearing in the block is comparatively uniform. Therefore, when the block size is large, it is predicted that the quality of motion compensation is not greatly reduced even if the granularity of specification of a path is decreased. Accordingly, in the present embodiment, depending on the block size, the motion vector determination section 46 quantizes the path of each point of intersection by a unit quantity larger than one pixel. More specifically, the motion vector determination section 46 sets a larger unit quantity for quantization of a path as the block size is larger.

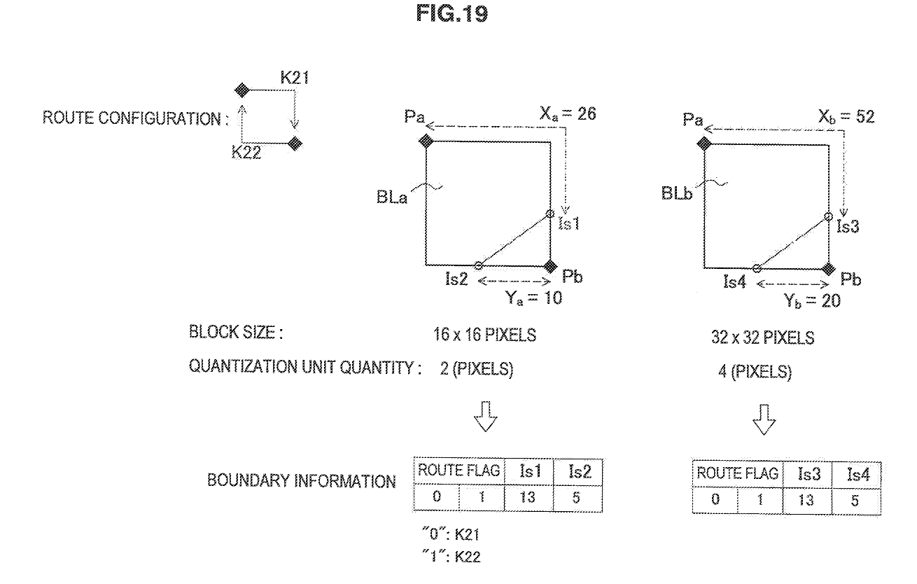

FIG. 19 is an explanatory diagram for describing an example of quantization of boundary information by the motion vector determination section 46. Referring to FIG. 19, a block BLa whose block size is 16×16 pixels, and a block BLb whose block size is 32×32 pixels are shown. Additionally, for example, the perimeter of each block is assumed to have been divided into two routes K21 and K22 having reference points Pa and Pb as the starting points, respectively.

A first point of intersection Is1 of the block BLa belongs to a route K21. A path Xₐ from a reference point Pa to the first point of intersection Is1 is measured to be 26 pixels. A second point of intersection Is2 belongs to a route K22. A path Yₐ from a reference point Pa to the second point of intersection 1s2 is measured to be 10 pixels. Here, the unit quantity of quantization of a path for a block whose block size is 16×16 pixels is assumed to be two (pixels), for example. The path Xₐ of the first point of intersection Is1 is calculated to be 26/2=13 by quantization. Similarly, the path Yₐ of the second point of intersection Is2 is calculated to be 10/2=5 by quantization. Accordingly, the boundary information generated by the motion vector determination section 46 includes, in addition to the route flag for identifying the route of each point of intersection (“0” meaning the route K21, and “1” meaning the route K22), a path “13” of the first point of intersection Is1 after quantization and a path “5” of the second point of intersection Is2 after quantization.

A first point of intersection Is3 of the block BLb belongs to a route K21. A path X_{b} from a reference point Pa to the first point of intersection Is3 is measured to be 52 pixels. A second point of intersection Is4 belongs to a route K22. A path Y_{b} from a reference point Pb to the second point of intersection Is4 is measured to be 20 pixels. Here, the unit quantity of quantization of a path for a block whose block size is 32×32 pixels is assumed to be four (pixels), for example. The path X_{b} of the first point of intersection Is3 is calculated to be 52/4=13 by quantization. Similarly, the path Y_{b} of the second point of intersection Is4 is calculated to be 20/4=5 by quantization. Accordingly, the boundary information generated by the motion vector determination section 46 includes, in addition to the route flag for identifying the route of each point of intersection (“0” meaning the route K21, and “1” meaning the route K22), a path “13” of the first point of intersection Is3 after quantization and a path “5” of the second point of intersection Is4 after quantization.

Such unit quantity of quantization may be commonly defined for an image encoding device and an image decoding device in advance. In this case, the motion vector determination section 46 does not output the information about the unit quantity. On the other hand, in the case there is no common definition, the motion vector determination section 46 may output the information about the unit quantity of quantization by including the same in the boundary information.

### 2. Flow of Process at the Time of Encoding According to an Embodiment

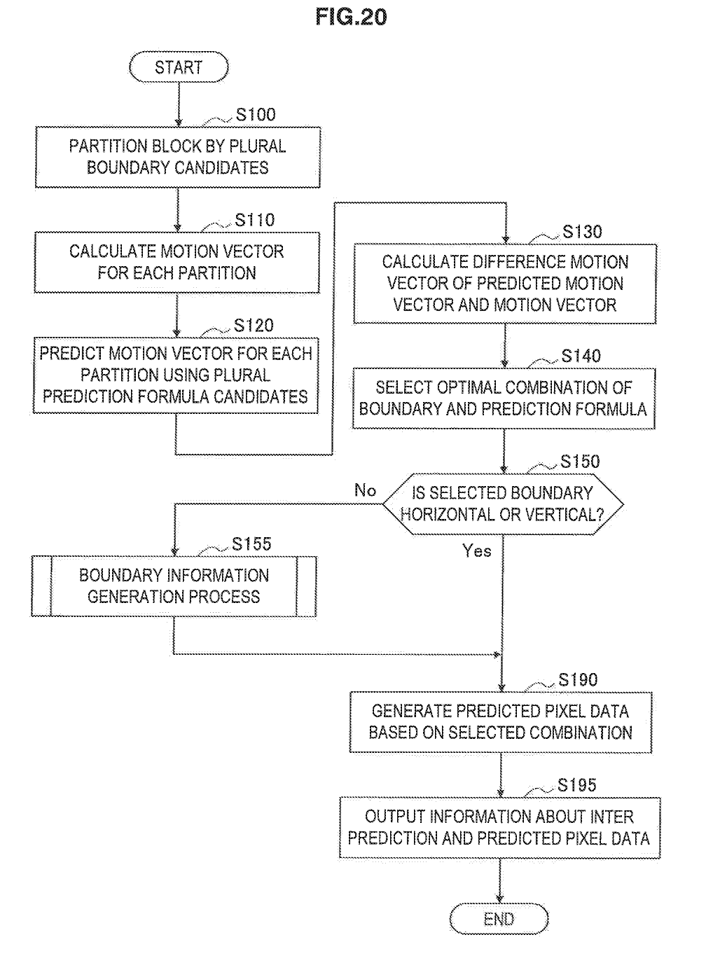

Next, flows of processes at the time of encoding will be described using FIGS. 20 to 23.

[2-1. Motion Estimation Process]

FIG. 20 is a flow chart showing an example of a flow of a motion estimation process of the motion estimation section 40 according to the present embodiment.

Referring to FIG. 20, first, the estimation processing section 41 partitions a block set in an image into a plurality of partitions by a plurality of boundary candidates including a boundary having an inclination (step S100). For example, a first boundary candidate is a boundary along a horizontal direction or a vertical direction according to H.264/AVC, and each block may be partitioned into a plurality of rectangular partitions by the first boundary candidate. Also, a second boundary candidate is a boundary having an inclination (a sloping boundary) according to the geometry motion partitioning, and each block may be partitioned into a plurality of non-rectangular partitions by the second boundary candidate.

Next, the motion vector calculation section 42 calculates a motion vector for each partition based on a pixel value of a reference image and a pixel value of an original image in each partition (step S110).

Next, the motion vector prediction section 45 predicts, for each partition, motion vectors to be used for prediction of a pixel value in each partition of the block partitioned by the boundary, using a plurality of prediction formula candidates (step S120). Next, the motion vector prediction section 45 calculates, for each combination of a boundary and a prediction formula as candidates, a difference motion vector representing a difference between a motion vector calculated by the motion vector calculation section 42 and a predicted motion vector (step S130).

Next, based on the prediction results of the motion vector prediction section 45, the motion vector determination section 46 evaluates a cost function value for each combination of a boundary and a prediction formula, and selects a combination of a boundary and a prediction formula that achieves the highest encoding efficiency (step S140). A cost function used by the motion vector determination section 46 may be a function that is based on differential energy between an original image and a decoded image, and an occurring bit rate.

Next, the motion vector determination section 46 decides whether or not the boundary selected in step S140 is a horizontal or vertical boundary as shown in FIGS. 3 and 4 (step S150). Then, in the case the selected boundary is not a horizontal or vertical boundary, the motion vector determination section 46 performs a boundary information generation process, which is described later in detail (step S155).

Next, the compensation section 47 calculates a predicted pixel value regarding a pixel in the encoding target block using the optimal boundary and the optimal prediction formula selected by the motion vector determination section 46, and generates predicted pixel data (step S190). Then, the compensation section 47 outputs information about inter prediction and the predicted pixel data to the mode selection section 50 (step S195). The information about inter prediction may include the boundary information generated in step S155, prediction formula information identifying the optimal prediction formula, corresponding difference motion vector information, reference image information, corresponding cost function value and the like, for example. The boundary information that is output here may be variable-coded by the lossless encoding section 16 shown in FIG. 1, for example. Additionally, a motion vector that is finally set for each partition in each block is stored in the motion vector buffer 43 as a reference motion vector. Also, the boundary information is stored in the boundary information buffer 44.

[2-2. Boundary Information Generation Process (No Division of Perimeter)]

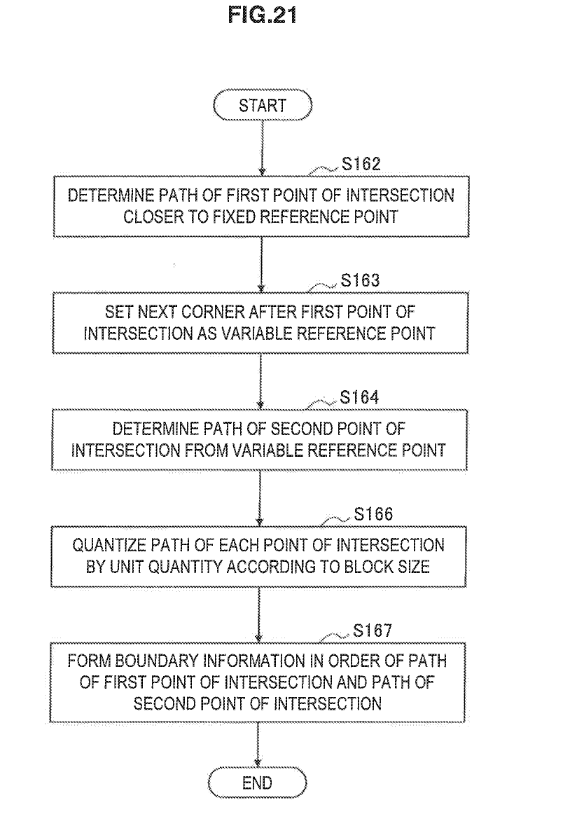

FIG. 21 is a flow chart showing a first example of the flow of a boundary information generation process, corresponding to the process of step S155 in FIG. 20, of the motion vector determination section 46. The example of FIG. 21 shows a flow of a process for a case where the perimeter of a block is not divided (that is, a case where only one route is set on the perimeter).

Referring to FIG. 21, first, the motion vector determination section 46 determines a path, along a route on the perimeter of a block, of a first point of intersection located closer to a fixed reference point (step S162). Next, the motion vector determination section 46 sets the next corner after the first point of intersection on the route as a variable reference point (step S163). Then, the motion vector determination section 46 determines a path of the second point of intersection on the route from the variable reference point (step S164). Then, the motion vector determination section 46 quantizes the path of each point of intersection determined in steps S162 and S164 by the unit quantity selected according to the block size (step S166). Moreover, the motion vector determination section 46 forms boundary information in the order of the quantized path of the first point of intersection and the quantized path of the second point of intersection (step S167).

[2-3. Boundary Information Generation Process (Division of Perimeter into Two)]

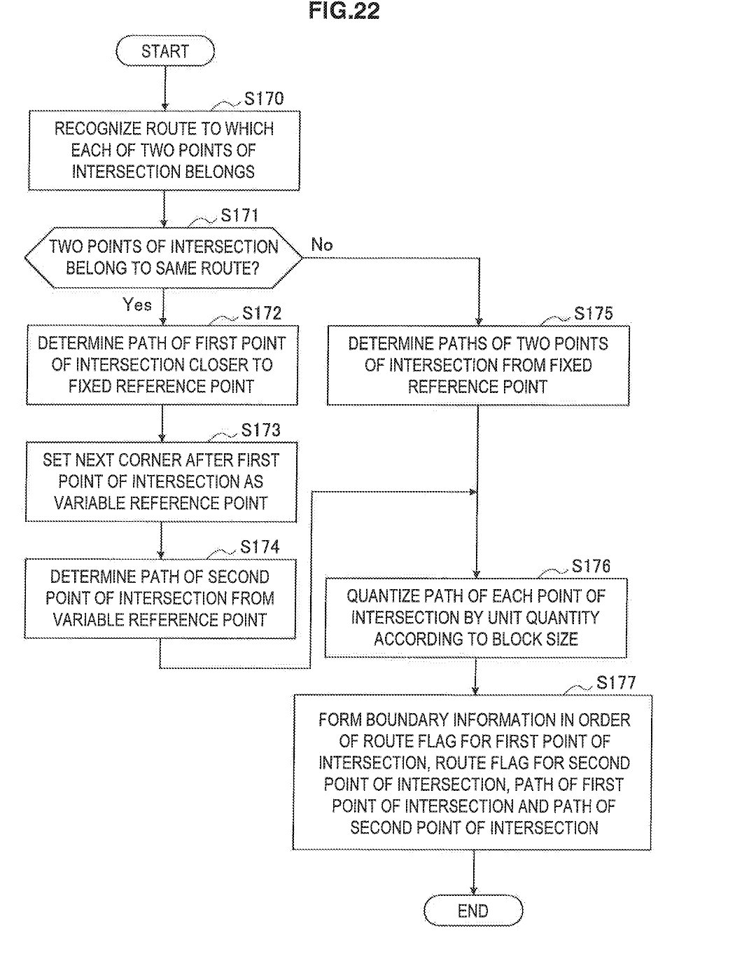

FIG. 22 is a flow chart showing a second example of the flow of a boundary information generation process, corresponding to the process of step S155 in FIG. 20, of the motion vector determination section 46. The example of FIG. 22 shows a flow of a process for a case where the perimeter of a block is divided into two routes.

Referring to FIG. 22, first, the motion vector determination section 46 recognizes the routes that two points of intersection of the perimeter of a block and a boundary belong to (step S170). Next, the motion vector determination section 46 decides whether or not the two points of intersection belong to the same route (step S171). Here, in the case the two points of intersection belong to the same route, the process proceeds to step S172. On the other hand, in the case the two points of intersection do not belong to the same route, the process proceeds to step S175.

In step S172, the motion vector determination section 46 determines a path, along a route on the perimeter of the block, of a first point of intersection located closer to a fixed reference point (step S172). Next, the motion vector determination section 46 sets the next corner after the first point of intersection on the route as a variable reference point (step S173). Then, the motion vector determination section 46 determines a path of the second point of intersection on the route from the variable reference point (step S174). On the other hand, in step S175, the motion vector determination section 46 determines the path of each of the points of intersection from the fixed reference point along the respective routes (step S175).

Then, the motion vector determination section 46 quantizes the path of each of the points of intersection determined in step S172 and S174 or S175 by the unit quantity selected according to the block size (step S176). Moreover, the motion vector determination section 46 forms boundary information in the order of the route flag for the first point of intersection, the route flag for the second point of intersection, the quantized path of the first point of intersection and the quantized path of the second point of intersection (step S177).

[2-4. Boundary Information Generation Process (Division of Perimeter into Four)]

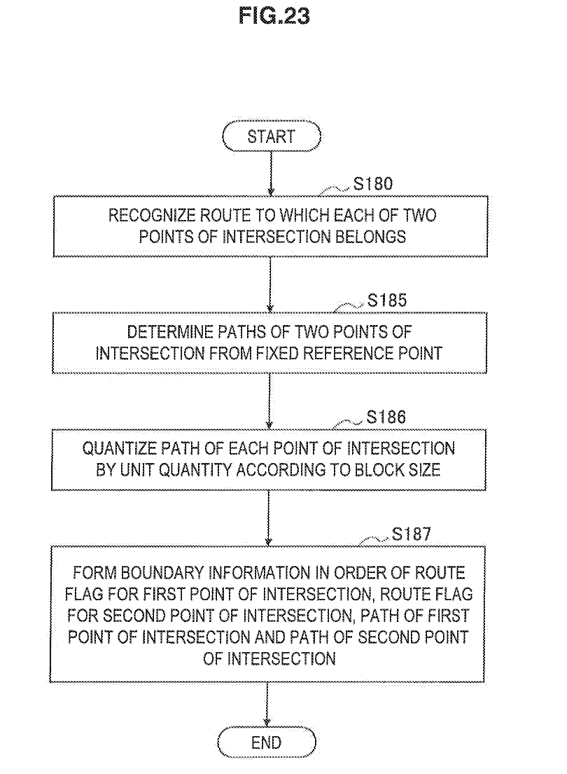

FIG. 23 is a flow chart showing a third example of the flow of a boundary information generation process, corresponding to the process of step S155 in FIG. 20, of the motion vector determination section 46. The example of FIG. 23 shows a flow of a process for a case where the perimeter of a block is divided into four routes each corresponding to a side.

Referring to FIG. 23, first, the motion vector determination section 46 recognizes the routes that two points of intersection of the perimeter of a block and a boundary belong to (step S180). Then, the motion vector determination section 46 determines the path of each of the points of intersection from a fixed reference point along the respective routes (step S185). Then, the motion vector determination section 46 quantizes the path of each point of intersection determined in step S185 by the unit quantity selected according to the block size (step S186). Moreover, the motion vector determination section 46 forms boundary information in the order of the route flag for the first point of intersection, the route flag for the second point of intersection, the quantized path of the first point of intersection and the quantized path of the second point of intersection (step S187).

### 3. Example Configuration of Image Decoding Device According to an Embodiment

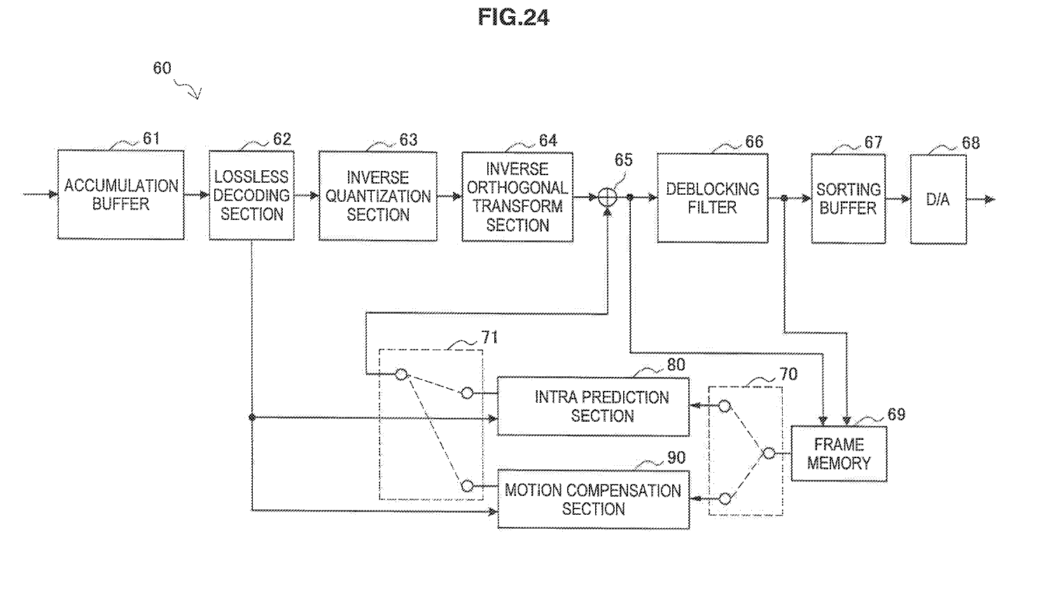

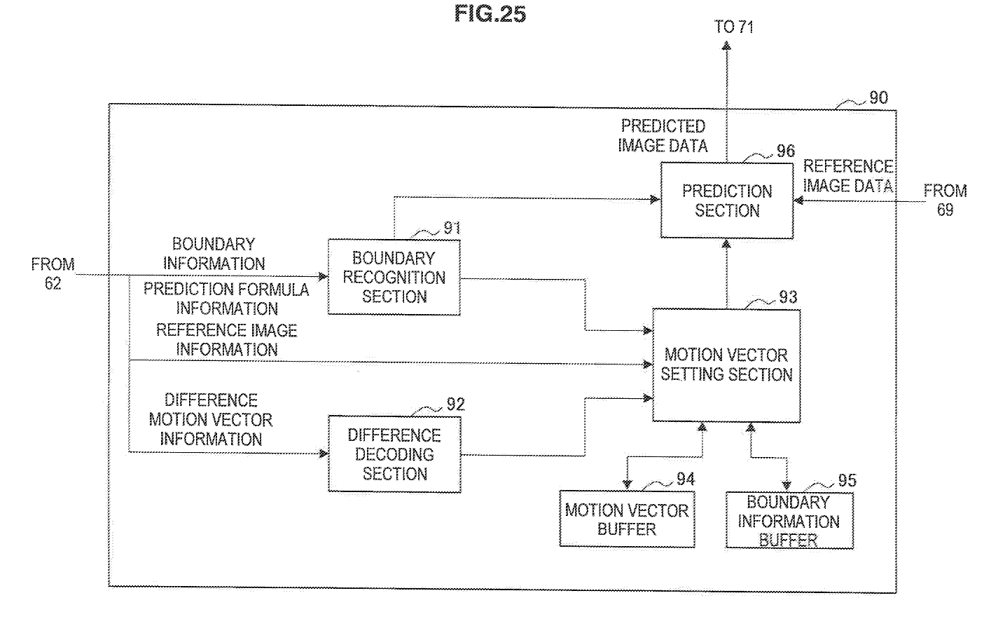

In this section, an example configuration of an image decoding device according to an embodiment will be described using FIGS. 24 and 25.

[3-1. Example of Overall Configuration]

FIG. 24 is a block diagram showing an example of a configuration of an image decoding device 60 according to an embodiment. Referring to FIG. 24, the image decoding device 60 includes an accumulation buffer 61, a lossless decoding section 62, an inverse quantization section 63, an inverse orthogonal transform section 64, an addition section 65, a deblocking filter 66, a sorting buffer 67, a D/A (Digital to Analogue) conversion section 68, a frame memory 69, selectors 70 and 71, an intra prediction section 80 and a motion compensation section 90.

The accumulation buffer 61 temporarily stores an encoded stream input via a transmission line using a storage medium.

The lossless decoding section 62 decodes an encoded stream input from the accumulation buffer 61 according to the encoding method used at the time of encoding. Also, the lossless decoding section 62 decodes information multiplexed to the header region of the encoded stream. Information that is multiplexed to the header region of the encoded stream may include information about intra prediction and information about inter prediction in the block header, for example. The lossless decoding section 62 outputs the information about intra, prediction to the intra prediction section 80. Also, the lossless decoding section 62 outputs the information about inter prediction to the motion compensation section 90.

The inverse quantization section 63 inversely quantizes quantized data which has been decoded by the lossless decoding section 62. The inverse orthogonal transform section 64 generates predicted error data by performing inverse orthogonal transformation on transform coefficient data input from the inverse quantization section 63 according to the orthogonal transformation method used at the time of encoding. Then, the inverse orthogonal transform section 64 outputs the generated predicted error data to the addition section 65.

The addition section 65 adds the predicted error data input from the inverse orthogonal transform section 64 and predicted image data input from the selector 71 to thereby generate decoded image data. Then, the addition section 65 outputs the generated decoded image data to the deblocking filter 66 and the frame memory 69.

The deblocking filter 66 removes block distortion by filtering the decoded image data input from the addition section 65, and outputs the decoded image data after filtering to the sorting buffer 67 and the frame memory 69.

The sorting buffer 67 generates a series of image data in a time sequence by sorting images input from the deblocking filter 66. Then, the sorting buffer 67 outputs the generated image data to the D/A conversion section 68.

The D/A conversion section 68 converts the image data in a digital format input from the sorting buffer 67 into an image signal in an analogue format. Then, the D/A conversion section 68 causes an image to be displayed by outputting the analogue image signal to a display (not shown) connected to the image decoding device 60, for example.

The frame memory 69 stores, using a storage medium, the decoded image data before filtering input from the addition section 65, and the decoded image data after filtering input from the deblocking filter 66.

The selector 70 switches the output destination of the image data from the frame memory 69 between the intra prediction section 80 and the motion compensation section 90 for each block in the image according to mode information acquired by the lossless decoding section 62. For example, in the case the intra prediction mode is specified, the selector 70 outputs the decoded image data before filtering that is supplied from the frame memory 69 to the intra prediction section 80 as reference image data. Also, in the case the inter prediction mode is specified, the selector 70 outputs the decoded image data after filtering that is supplied from the frame memory 69 to the motion compensation section 90 as the reference image data.

The selector 71 switches the output source of predicted image data to be supplied to the addition section 65 between the intra prediction section 80 and the motion compensation section 90 for each block in the image according to the mode information acquired by the lossless decoding section 62. For example, in the case the intra prediction mode is specified, the selector 71 supplies to the addition section 65 the predicted image data output from the intra prediction section 80. In the case the inter prediction mode is specified, the selector 71 supplies to the addition section 65 the predicted image data output from the motion compensation section 90.

The intra prediction section 80 performs in-screen prediction of a pixel value based on the information about intra prediction input from the lossless decoding section 62 and the reference image data from the frame memory 69, and generates predicted image data. Then, the intra prediction section 80 outputs the generated predicted image data to the selector 71.

The motion compensation section 90 performs a motion compensation process based on the information about inter prediction input from the lossless decoding section 62 and the reference image data from the frame memory 69, and generates predicted image data. Then, the motion compensation section 90 outputs the generated predicted image data to the selector 71.

[3-2. Example Configuration of Motion Compensation Section]

FIG. 25 is a block diagram showing an example of a detailed configuration of the motion compensation section 90 of the image decoding device 60 shown in FIG. 24. Referring to FIG. 25, the motion compensation section 90 includes a boundary recognition section 91, a difference decoding section 92, a motion vector setting section 93, a motion vector buffer 94, a boundary information buffer 95 and a prediction section 96.

The boundary recognition section 91 recognizes a boundary which has partitioned a block in an image into a plurality of partitions at the time of encoding of the image. Such a boundary is a boundary that is selected from a plurality of candidates including a boundary having an inclination. More specifically, the boundary recognition section 91 first acquires boundary information included in information about inter prediction input from the lossless decoding section 62. The boundary information that is acquired here is information specifying a plurality of points of intersection of the perimeter of the block and the boundary. Then, the boundary recognition section 91 recognizes the boundary which has partitioned each block based on the acquired boundary information. The flow of a boundary recognition process of the boundary recognition section 91 will be more specifically described later.

The difference decoding section 92 decodes a difference motion vector calculated at the time of encoding for each partition, based on difference motion vector information included in the information about inter prediction input from the lossless decoding section 62. Then, the difference decoding section 92 outputs the difference motion vector to the motion vector setting section 93.

The motion vector setting section 93 sets a reference pixel position in each partition which has been partitioned off by the boundary, according to the boundary recognized by the boundary recognition section 91. At this time, since the point of intersection of the perimeter of the block and the boundary is directly specified by the boundary information, the motion vector setting section 93 can easily set the reference pixel position in each partition with a small amount of computation. Also, the motion vector setting section 93 acquires from the motion vector buffer 94 a motion vector of a reference block or a reference partition (that is, a reference motion vector) corresponding to the reference pixel position which has been set. Then, the motion vector setting section 93 sets a motion vector to be used for prediction of a pixel value in each partition based on the acquired reference motion vector.

More specifically, first, the motion vector setting section 93 acquires prediction formula information included in the information about inter prediction input from the lossless decoding section 62. The prediction formula information may be acquired in association with each partition. Next, the motion vector setting section 93 substitutes the reference motion vector in the prediction formula identified by the prediction formula information, and calculates a predicted motion vector. Moreover, the motion vector setting section 93 calculates a motion vector by adding the difference motion vector input from the difference decoding section 92 to the calculated predicted motion vector. The motion vector setting section 93 sets the motion vector calculated in this manner for each partition. Also, the motion vector setting section 93 outputs the motion vector set for each partition to the motion vector buffer 94, and also, outputs the boundary information to the boundary information buffer 95.

The motion vector buffer 94 temporarily stores, using a storage medium, a motion vector which is referred to in the motion vector setting process of the motion vector setting section 93. Motion vectors to be referred to in the motion vector buffer 94 may include a motion vector set for a block or a partition in a reference image which is already encoded, and a motion vector set for another block or partition in an encoding target image.

The boundary information buffer 95 temporarily stores, using a storage medium, the boundary information which is referred to in the motion vector setting process of the motion vector setting section 93. The boundary information that is stored in the boundary information buffer 95 may be referred to identify a reference block or a reference partition corresponding to a reference pixel position, for example.

The prediction section 96 generates a predicted pixel value for each partition in a block partitioned by the boundary recognized by the boundary recognition section 91, using the motion vector set by the motion vector setting section 93, the reference image information, and the reference image data input from the frame memory 69. Then, the prediction section 93 outputs predicted image data including the generated predicted pixel value to the selector 71.

### 4. Flow of Process at the Time of Decoding According to an Embodiment

[4-1. Motion Compensation Process]

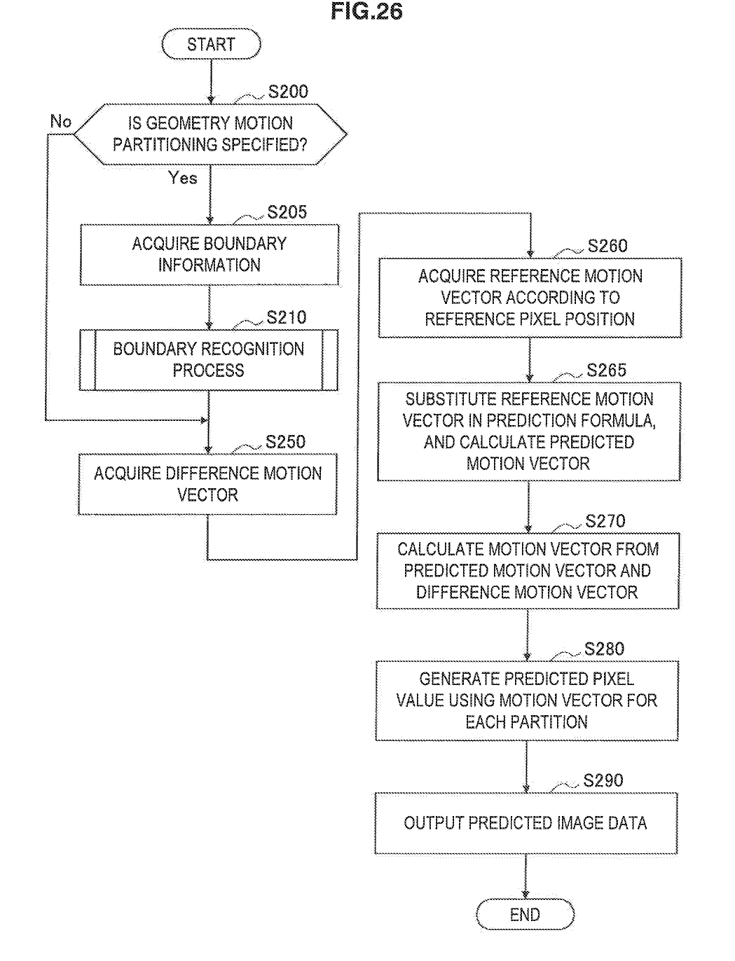

Next, a flow of a process at the time of decoding will be described using FIG. 26. FIG. 26 is a flow chart showing an example of a flow of the motion compensation process of the motion compensation section 90 of the image decoding device 60 according to the present embodiment.

Referring to FIG. 26, first, the boundary recognition section 91 of the image encoding device 60 decides whether geometry motion partitioning is specified or not (step S200). For example, the boundary recognition section 91 may decide whether the geometry motion partitioning is specified or not by referring to the prediction mode included in information about inter prediction. In the case the geometry motion partitioning is specified here, the process proceeds to step S205. On the other hand, in the case the geometry motion partitioning is not specified, a block is partitioned by a horizontal or vertical boundary as illustrated in FIGS. 3 and 4. In this case, the process proceeds to step S250.

In step S205, the boundary recognition section 91 acquires boundary information included in the information about inter prediction input from the lossless decoding section 62 (step S205). Then, the boundary recognition section 91 performs a boundary recognition process that is described later in detail (step S210).

Next, the difference decoding section 92 acquires a difference motion vector based on difference motion vector information included in the information about inter prediction input from the lossless decoding section 62 (step S250). Then, the difference decoding section 92 outputs the acquired difference motion vector to the motion vector setting section 93.

Then, the motion vector setting section 93 acquires from the motion vector buffer 94 a reference motion vector which is a motion vector set for a block or a partition corresponding to the reference pixel position according to the boundary recognized by the boundary recognition section 91 (step S260).

Next, the motion vector setting section 93 calculates a predicted motion vector for each partition by substituting a reference motion vector into a prediction formula recognized from prediction formula information included in the information about inter prediction input from the lossless decoding section 62 (step S265).

Next, the motion vector setting section 93 calculates a motion vector for each partition by adding the difference motion vector input from the difference decoding section 92 to the predicted motion vector which has been calculated (step S270). The motion vector setting section 93 calculates a motion vector for each partition in this manner, and sets the motion vector which has been calculated in each partition.

Next, the prediction section 94 generates a predicted pixel value using the motion vector set by the motion vector setting section 93, reference image information, and the reference image data input from the frame memory 69 (step S280). Then, the prediction section 94 outputs predicted image data including the generated predicted pixel value to the selector 71 (step S290).

[4-2. Boundary Recognition Process (No Division of Perimeter)]

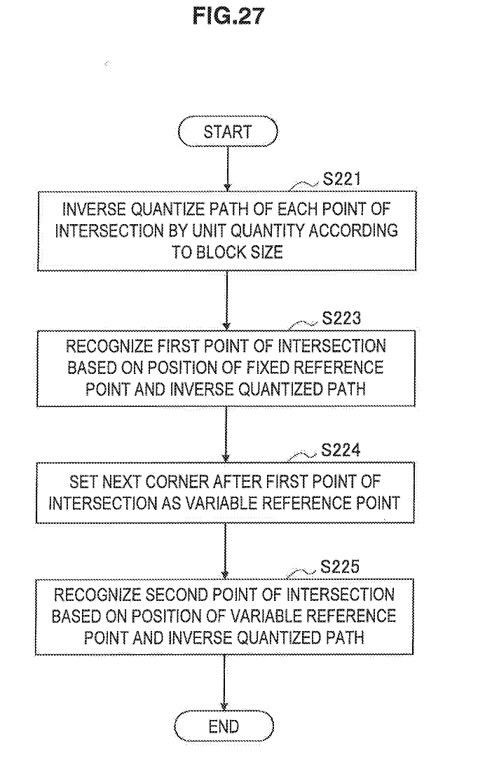

FIG. 27 is a flow chart showing a first example of a flow of the boundary recognition process of the boundary recognition section 91 corresponding to the process of step S210 in FIG. 26. The example of FIG. 27 shows a flow of the process for a case where the perimeter of a block is not divided (that is, a case where only one route is set on the perimeter).

Referring to FIG. 27, first, the boundary recognition section 91 inverse quantizes the path of each point of intersection included in boundary information by the unit quantity according to the block size (step S221). The unit quantity of inverse quantization here is a unit quantity larger than one pixel, for example, and the value may be larger as the block size is larger, as described in relation to FIG. 19. Next, the boundary recognition section 91 recognizes a first point of intersection based on the path of the first point of intersection after inverse quantization and the position of a fixed reference point (step S223). Then, boundary recognition section 91 sets the next corner after the first point of intersection on the route as a variable reference point (step S224). Then, the boundary recognition section 91 recognizes a second point of intersection based on the path of the second point of intersection after inverse quantization and the position of the variable reference point (step S225).

[4-3. Boundary Recognition Process (Division of Perimeter into Two)]

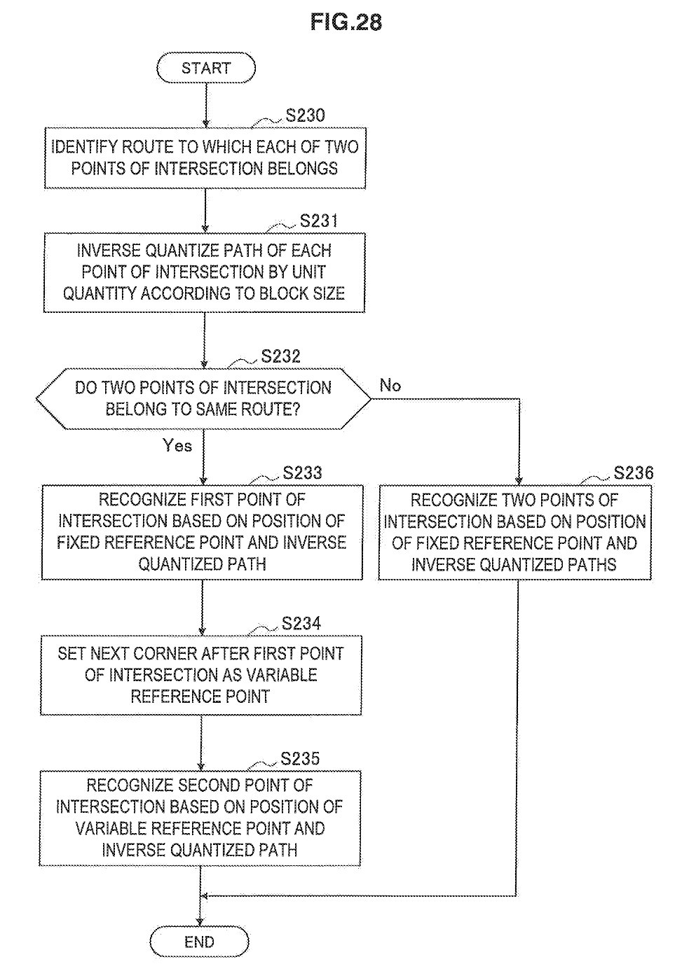

FIG. 28 is a flow chart showing a second example of a flow of the boundary recognition process of the boundary recognition section 91 corresponding to the process of step S210 in FIG. 26. The example of FIG. 28 shows a flow of the process for a case where the perimeter of a block is divided into two routes. In this case, the boundary information includes information identifying a route to which each point of intersection belongs (hereinafter, referred to as route identification information) and a path along the route from a reference point set on this route.

Referring to FIG. 28, first, the boundary recognition section 91 recognizes the routes to which two points of intersection of the perimeter of a block and a boundary respectively belong, based on route identification information included in boundary information (step S230). Next, the boundary recognition section 91 inverse quantizes the path of each point of intersection included in the boundary information by the unit quantity according to the block size (step S231). Next, the boundary recognition section 91 decides whether the two points of intersection belong to the same route or not, based on the result of identification in step S230 (step S232). In the case the two points of intersection belong to the same route here, the process proceeds to step S233. On the other hand, in the case the two points of intersection do not belong to the same route, the process proceeds to step S236.

In step S233, the boundary recognition section 91 recognizes a first point of intersection based on the path of the first point of intersection after inverse quantization and the position of a fixed reference point on the route to which the two points of intersection belong (step S223). Then, boundary recognition section 91 sets the next corner after the first point of intersection on the route as a variable reference point (step S234). Then, the boundary recognition section 91 recognizes the second point of intersection based on the path of the second point of intersection after inverse quantization and the position of the variable reference point (step S235).

On the other hand, in step S236, the boundary recognition section 91 recognizes the two points of intersection based on the fixed reference points on the routes to which the two points of intersection respectively belong and the paths after inverse quantization (step S236).

[4-4. Boundary Recognition Process (Division of Perimeter into Four)]

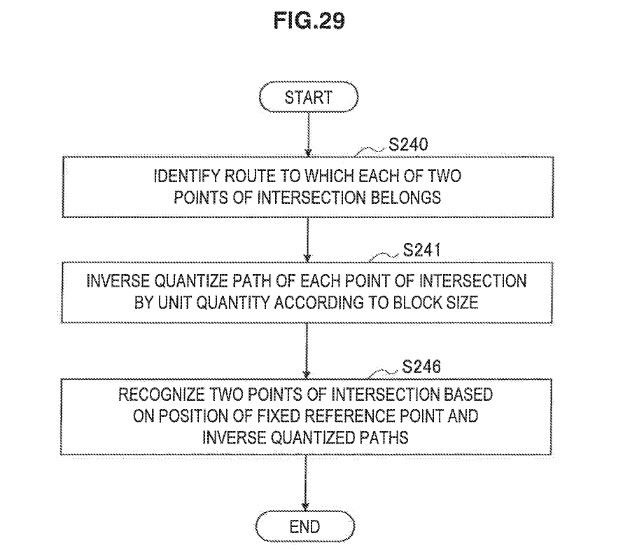

FIG. 29 is a flow chart showing a third example of a flow of the boundary recognition process of the boundary recognition section 91 corresponding to the process of step S210 in FIG. 26. The example of FIG. 29 shows a flow of the process for a case where the perimeter of a block is divided into four routes. In this case, the boundary information includes information identifying a route to which each point of intersection belongs and a path along the route from a reference point set on this route.

Referring to FIG. 29, first, the boundary recognition section 91 recognizes the routes to which two points of intersection of the perimeter of a block and a boundary respectively belong, based on route identification information included in boundary information (step S240). Next, the boundary recognition section 91 inverse quantizes the path of each point of intersection included in the boundary information by the unit quantity according to the block size (step S241). Next, the boundary recognition section 91 recognizes the two points of intersection based on fixed reference points on the routes to which the two points of intersection respectively belong and the paths after inverse quantization (step S246).

In this manner, by using the boundary information described in the present specification, also in the case of the geometry motion partitioning, a point of intersection of the perimeter of a block and a boundary can be easily recognized with a small amount of computation, without geometric calculation.

### 5. Example Application

The image encoding device 10 and the image decoding device 60 according to the embodiment described above may be applied to various electronic appliances such as a transmitter and a receiver for satellite broadcasting, cable broadcasting such as cable TV, distribution on the Internet, distribution to terminals via cellular communication, and the like, a recording device that records images in a medium such as an optical disc, a magnetic disk or a flash memory, a reproduction device that reproduces images from such storage medium, and the like. Four example applications will be described below.

[5-1. First Example Application]

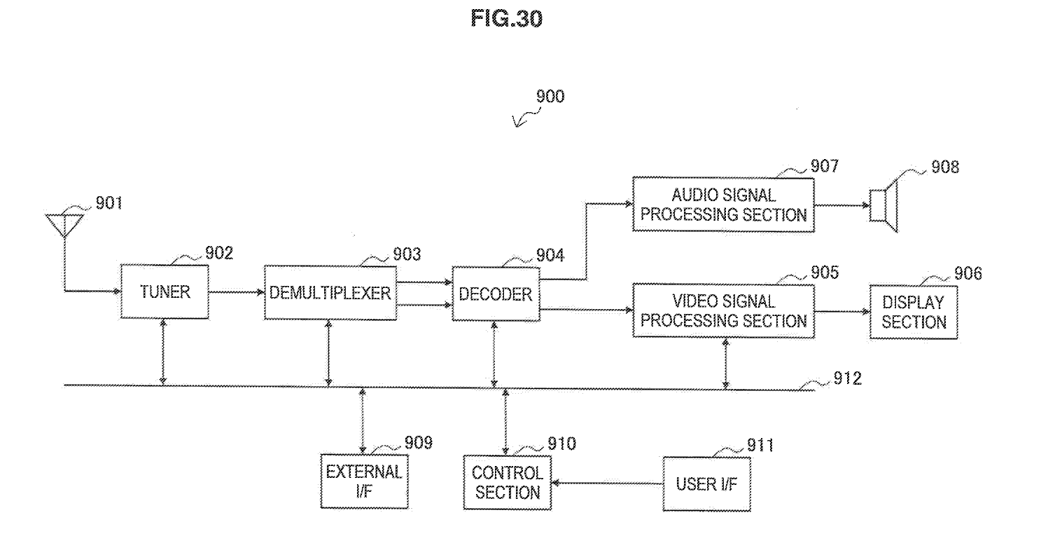

FIG. 30 is a block diagram showing an example of a schematic configuration of a television adopting the embodiment described above. A television 900 includes an antenna 901, a tuner 902, a demultiplexer 903, a decoder 904, an video signal processing section 905, a display section 906, an audio signal processing section 907, a speaker 908, an external interface 909, a control section 910, a user interface 911, and a bus 912.

The tuner 902 extracts a signal of a desired channel from broadcast signals received via the antenna 901, and demodulates the extracted signal. Then, the tuner 902 outputs an encoded bit stream obtained by demodulation to the demultiplexer 903. That is, the tuner 902 serves as transmission means of the televisions 900 for receiving an encoded stream in which an image is encoded.

The demultiplexer 903 separates a video stream and an audio stream of a program to be viewed from the encoded bit stream, and outputs each stream which has been separated to the decoder 904. Also, the demultiplexer 903 extracts auxiliary data such as an EPG (Electronic Program Guide) from the encoded bit stream, and supplies the extracted data to the control section 910. Additionally, the demultiplexer 903 may perform descrambling in the case the encoded bit stream is scram bled.

The decoder 904 decodes the video stream and the audio stream input from the demultiplexer 903. Then, the decoder 904 outputs video data generated by the decoding process to the video signal processing section 905. Also, the decoder 904 outputs the audio data generated by the decoding process to the audio signal processing section 907.

The video signal processing section 905 reproduces the video data input from the decoder 904, and causes the display section 906 to display the video. The video signal processing section 905 may also cause the display section 906 to display an application screen supplied via a network. Further, the video signal processing section 905 may perform an additional process such as noise removal, for example, on the video data according to the setting. Furthermore, the video signal processing section 905 may generate an image of a GUI (Graphical User Interface) such as a menu, a button, a cursor or the like, for example, and superimpose the generated image on an output image.

The display section 906 is driven by a drive signal supplied by the video signal processing section 905, and displays a video or an image on an video screen of a display device (for example, a liquid crystal display, a plasma display, an OLED, or the like).

The audio signal processing section 907 performs reproduction processes such as D/A conversion and amplification on the audio data input from the decoder 904, and outputs audio from the speaker 908. Also, the audio signal processing section 907 may perform an additional process such as noise removal on the audio data.

The external interface 909 is an interface for connecting the television 900 and an external appliance or a network. For example, a video stream or an audio stream received via the external interface 909 may be decoded by the decoder 904. That is, the external interface 909 also serves as transmission means of the televisions 900 for receiving an encoded stream in which an image is encoded.

The control section 910 includes a processor such as a CPU (Central Processing Unit), and a memory such as an RAM (Random Access Memory), an ROM (Read Only Memory), or the like. The memory stores a program to be executed by the CPU, program data, EPG data, data acquired via a network, and the like. The program stored in the memory is read and executed by the CPU at the time of activation of the television 900, for example. The CPU controls the operation of the television 900 according to an operation signal input from the user interface 911, for example, by executing the program.

The user interface 911 is connected to the control section 910. The user interface 911 includes a button and a switch used by a user to operate the television 900, and a receiving section for a remote control signal, for example. The user interface 911 detects an operation of a user via these structural elements, generates an operation signal, and outputs the generated operation signal to the control section 910.

The bus 912 interconnects the tuner 902, the demultiplexer 903, the decoder 904, the video signal processing section 905, the audio signal processing section 907, the external interface 909, and the control section 910.

In the television 900 configured in this manner, the decoder 904 has a function of the image decoding device 60 according to the embodiment described above. Accordingly, in the case a block is partitioned by a boundary that can be formed in various shapes other than rectangle, it is possible to compensate motion with less amount of computation compared to existing methods.

[5-2. Second Example Application]

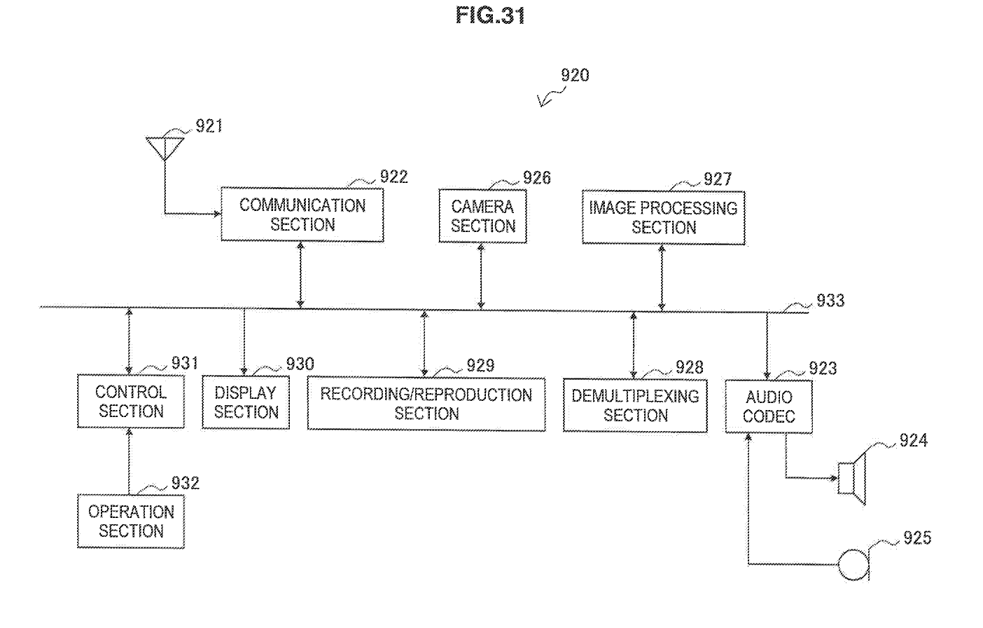

FIG. 31 is a block diagram showing an example of a schematic configuration of a mobile phone adopting the embodiment described above. A mobile phone 920 includes an antenna 921, a communication section 922, an audio codec 923, a speaker 924, a microphone 925, a camera section 926, an image processing section 927, a demultiplexing section 928, a recording/reproduction section 929, a display section 930, a control section 931, an operation section 932, and a bus 933.

The antenna 921 is connected to the communication section 922. The speaker 924 and the microphone 925 are connected to the audio codec 923. The operation section 932 is connected to the control section 931. The bus 933 interconnects the communication section 922, the audio codec 923, the camera section 926, the image processing section 927, the demultiplexing section 928, the recording/reproduction section 929, the display section 930, and the control section 931.

The mobile phone 920 performs operation such as transmission/reception of audio signal, transmission/reception of emails or image data, image capturing, recording of data, and the like, in various operation modes including an audio communication mode, a data communication mode, an image capturing mode, and a videophone mode.

In the audio communication mode, an analogue audio signal generated by the microphone 925 is supplied to the audio codec 923. The audio codec 923 converts the analogue audio signal into audio data, and AD converts and compresses the converted audio data. Then, the audio codec 923 outputs the compressed audio data to the communication section 922. The communication section 922 encodes and modulates the audio data, and generates a transmission signal. Then, the communication section 922 transmits the generated transmission signal to a base station (not shown) via the antenna 921. Also, the communication section 922 amplifies a wireless signal received via the antenna 921 and converts the frequency of the wireless signal, and acquires a received signal. Then, the communication section 922 demodulates and decodes the received signal and generates audio data, and outputs the generated audio data to the audio codec 923. The audio codec 923 extends and D/A converts the audio data, and generates an analogue audio signal. Then, the audio codec 923 supplies the generated audio signal to the speaker 924 and causes the audio to be output.

Also, in the data communication mode, the control section 931 generates text data that makes up an email, according to an operation of a user via the operation section 932, for example. Moreover, the control section 931 causes the text to be displayed on the display section 930. Furthermore, the control section 931 generates email data according to a transmission instruction of the user via the operation section 932, and outputs the generated email data to the communication section 922. Then, the communication section 922 encodes and modulates the email data, and generates a transmission signal. Then, the communication section 922 transmits the generated transmission signal to a base station (not shown) via the antenna 921. Also, the communication section 922 amplifies a wireless signal received via the antenna 921 and converts the frequency of the wireless signal, and acquires a received signal. Then, the communication section 922 demodulates and decodes the received signal, restores the email data, and outputs the restored email data to the control section 931. The control section 931 causes the display section 930 to display the contents of the email, and also, causes the email data to be stored in the storage medium of the recording/reproduction section 929.

The recording/reproduction section 929 includes an arbitrary readable and writable storage medium. For example, the storage medium may be a built-in storage medium such as an RAM, a flash memory or the like, or an externally mounted storage medium such as a hard disk, a magnetic disk, a magneto-optical disk, an optical disc, an USB memory, a memory card, or the like.

Furthermore, in the image capturing mode, the camera section 926 captures an image of a subject, generates image data, and outputs the generated image data to the image processing section 927, for example. The image processing section 927 encodes the image data input from the camera section 926, and causes the encoded stream to be stored in the storage medium of the recording/reproduction section 929.

Furthermore, in the videophone mode, the demultiplexing section 928 multiplexes a video stream encoded by the image processing section 927 and an audio stream input from the audio codec 923, and outputs the multiplexed stream to the communication section 922, for example. The communication section 922 encodes and modulates the stream, and generates a transmission signal. Then, the communication section 922 transmits the generated transmission signal to a base station (not shown) via the antenna 921. Also, the communication section 922 amplifies a wireless signal received via the antenna 921 and converts the frequency of the wireless signal, and acquires a received signal. These transmission signal and received signal may include an encoded bit stream. Then, the communication section 922 demodulates and decodes the received signal, restores the stream, and outputs the restored stream to the demultiplexing section 928. The demultiplexing section 928 separates a video stream and an audio stream from the input stream, and outputs the video stream to the image processing section 927 and the audio stream to the audio codec 923. The image processing section 927 decodes the video stream, and generates video data. The video data is supplied to the display section 930, and a series of images is displayed by the display section 930. The audio codec 923 extends and D/A converts the audio stream, and generates an analogue audio signal. Then, the audio codec 923 supplies the generated audio signal to the speaker 924 and causes the audio to be output.

In the mobile phone 920 configured in this manner, the image processing section 927 has a function of the image encoding device 10 and the image decoding device 60 according to the embodiment described above. Accordingly, in the case a block is partitioned by a boundary that can be formed in various shapes other than rectangle, it is possible to compensate motion with less amount of computation compared to existing methods.

[5-3. Third Example Application]

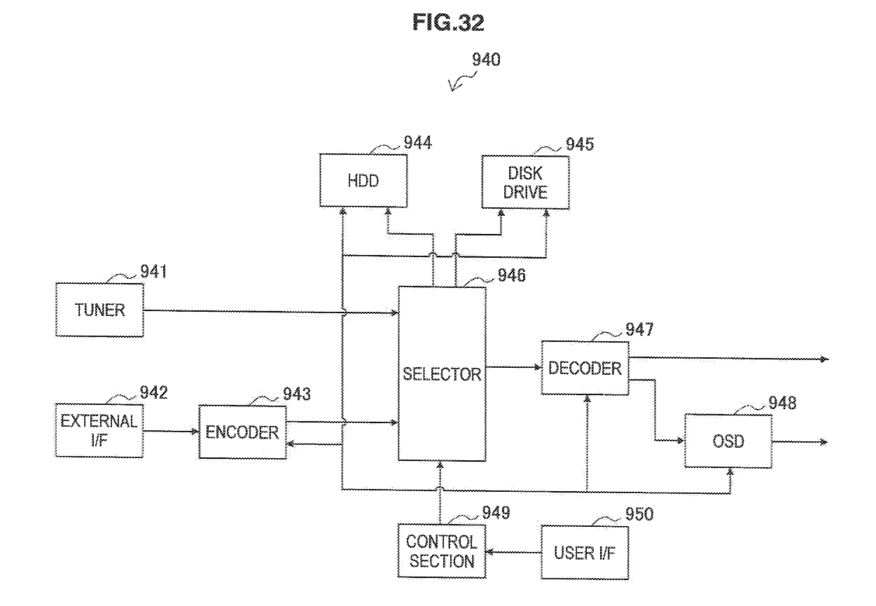

FIG. 32 is a block diagram showing an example of a schematic configuration of a recording/reproduction device adopting the embodiment described above. A recording/reproduction device 940 encodes, and records in a recording medium, audio data and video data of a received broadcast program, for example. The recording/reproduction device 940 may also encode, and record in the recording medium, audio data and video data acquired from another device, for example. Furthermore, the recording/reproduction device 940 reproduces, using a monitor or a speaker, data recorded in the recording medium, according to an instruction of a user, for example. At this time, the recording/reproduction device 940 decodes the audio data and the video data.

The recording/reproduction device 940 includes a tuner 941, an external interface 942, an encoder 943, an HDD (Hard Disk Drive) 944, a disc drive 945, a selector 946, a decoder 947, an OSD (On-Screen Display) 948, a control section 949, and a user interface 950.

The tuner 941 extracts a signal of a desired channel from broadcast signals received via an antenna (not shown), and demodulates the extracted signal. Then, the tuner 941 outputs an encoded bit stream obtained by demodulation to the selector 946. That is, the tuner 941 serves as transmission means of the recording/reproduction device 940.

The external interface 942 is an interface for connecting the recording/reproduction device 940 and an external appliance or a network. For example, the external interface 942 may be an IEEE 1394 interface, a network interface, an USB interface, a flash memory interface, or the like. For example, video data and audio data received by the external interface 942 are input to the encoder 943. That is, the external interface 942 serves as transmission means of the recording/reproduction device 940.

In the case the video data and the audio data input from the external interface 942 are not encoded, the encoder 943 encodes the video data and the audio data. Then, the encoder 943 outputs the encoded bit stream to the selector 946.

The HDD 944 records in an internal hard disk an encoded bit stream, which is compressed content data of a video or audio, various programs, and other pieces of data. Also, the HDD 944 reads these pieces of data from the hard disk at the time of reproducing a video or audio.

The disc drive 945 records or reads data in a recording medium that is mounted. A recording medium that is mounted on the disc drive 945 may be a DVD disc (a DVD-Video, a DVD-RAM, a DVD-R, a DVD-RW, a DVD+, a DVD+RW, or the like), a Blu-ray (registered trademark) disc, or the like, for example.

The selector 946 selects, at the time of recording a video or audio, an encoded bit stream input from the tuner 941 or the encoder 943, and outputs the selected encoded bit stream to the HDD 944 or the disc drive 945. Also, the selector 946 outputs, at the time of reproducing a video or audio, an encoded bit stream input from the HDD 944 or the disc drive 945 to the decoder 947.

The decoder 947 decodes the encoded bit stream, and generates video data and audio data. Then, the decoder 947 outputs the generated video data to the OSD 948. Also, the decoder 904 outputs the generated audio data to an external speaker.

The OSD 948 reproduces the video data input from the decoder 947, and displays a video. Also, the OSD 948 may superimpose an image of a GUI, such as a menu, a button, a cursor or the like, for example, on a displayed video.

The control section 949 includes a processor such as a CPU, and a memory such as an RAM or an ROM. The memory stores a program to be executed by the CPU, program data, and the like. A program stored in the memory is read and executed by the CPU at the time of activation of the recording/reproduction device 940, for example. The CPU controls the operation of the recording/reproduction device 940 according to an operation signal input from the user interface 950, for example, by executing the program.

The user interface 950 is connected to the control section 949. The user interface 950 includes a button and a switch used by a user to operate the recording/reproduction device 940, and a receiving section for a remote control signal, for example. The user interface 950 detects an operation of a user via these structural elements, generates an operation signal, and outputs the generated operation signal to the control section 949.

In the recording/reproduction device 940 configured in this manner, the encoder 943 has a function of the image encoding device 10 according to the embodiment described above. Also, the decoder 947 has a function of the image decoding device 60 according to the embodiment described above. Accordingly, in the case a block is partitioned by a boundary that can be formed in various shapes other than rectangle, it is possible to compensate motion with less amount of computation compared to existing methods.

[5-4. Fourth Example Application]

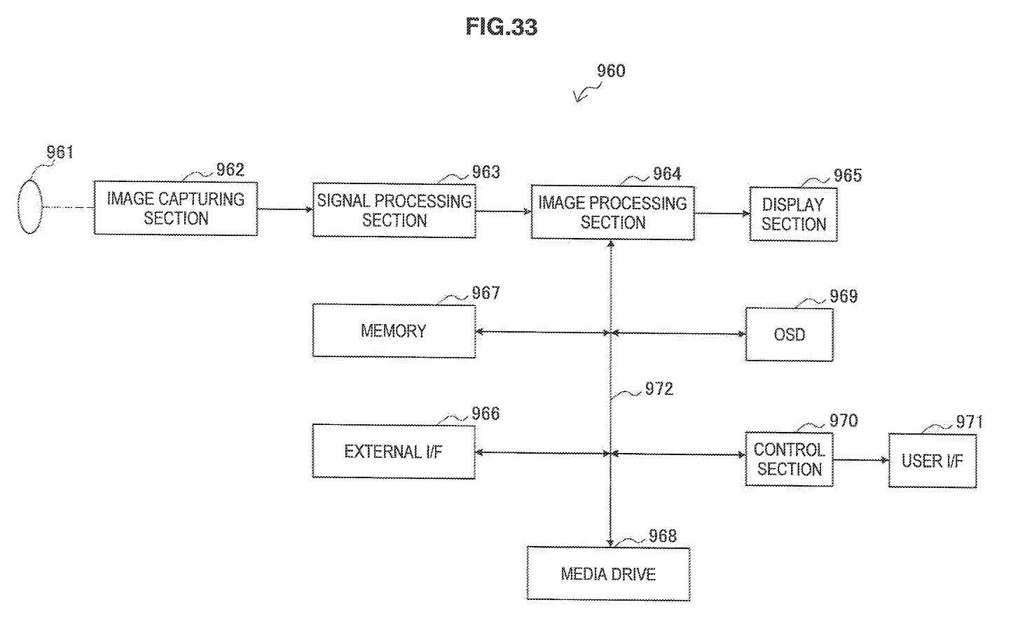

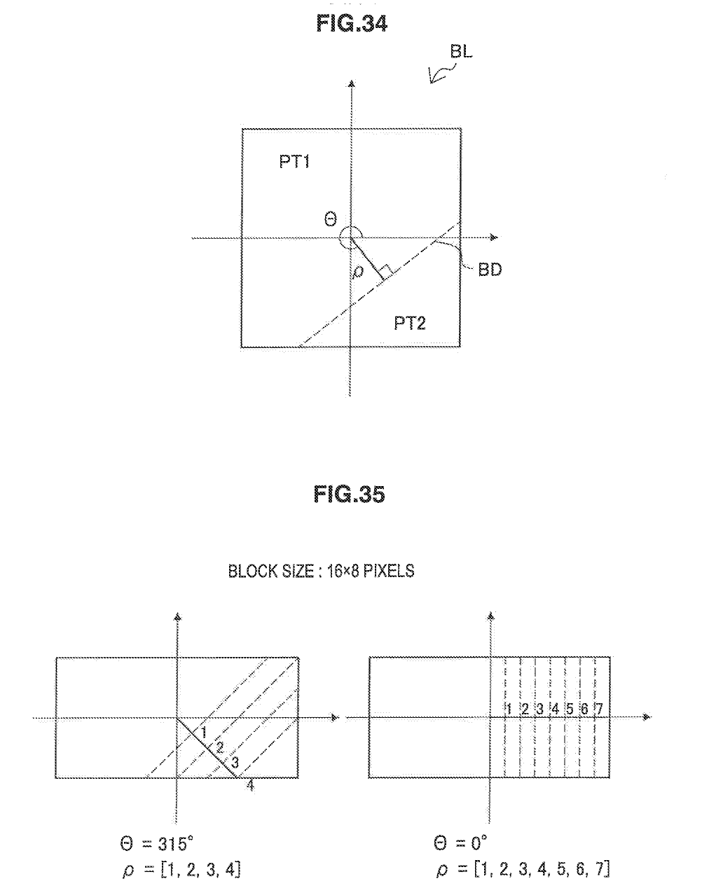

FIG. 33 is a block diagram showing an example of a schematic configuration of an image capturing device adopting the embodiment described above. An image capturing device 960 captures an image of a subject, generates an image, encodes the image data, and records the image data in a recording medium.

The image capturing device 960 includes an optical block 961, an image capturing section 962, a signal processing section 963, an image processing section 964, a display section 965, an external interface 966, a memory 967, a media drive 968, an OSD 969, a control section 970, a user interface 971, and a bus 972.

The optical block 961 is connected to the image capturing section 962. The image capturing section 962 is connected to the signal processing section 963. The display section 965 is connected to the image processing section 964. The user interface 971 is connected to the control section 970. The bus 972 interconnects the image processing section 964, the external interface 966, the memory 967, the media drive 968, the OSD 969, and the control section 970.

The optical block 961 includes a focus lens, an aperture stop mechanism, and the like. The optical block 961 forms an optical image of a subject on an image capturing surface of the image capturing section 962. The image capturing section 962 includes an image sensor such as a CCD, a CMOS or the like, and converts by photoelectric conversion the optical image formed on the image capturing surface into an image signal which is an electrical signal. Then, the image capturing section 962 outputs the image signal to the signal processing section 963.

The signal processing section 963 performs various camera signal processes, such as knee correction, gamma correction, color correction and the like, on the image signal input from the image capturing section 962. The signal processing section 963 outputs the image data after the camera signal process to the image processing section 964.

The image processing section 964 encodes the image data input from the signal processing section 963, and generates encoded data. Then, the image processing section 964 outputs the generated encoded data to the external interface 966 or the media drive 968. Also, the image processing section 964 decodes encoded data input from the external interface 966 or the media drive 968, and generates image data. Then, the image processing section 964 outputs the generated image data to the display section 965. Also, the image processing section 964 may output the image data input from the signal processing section 963 to the display section 965, and cause the image to be displayed. Furthermore, the image processing section 964 may superimpose data for display acquired from the OSD 969 on an image to be output to the display section 965.

The OSD 969 generates an image of a GUI, such as a menu, a button, a cursor or the like, for example, and outputs the generated image to the image processing section 964.

The external interface 966 is configured as an USB input/output terminal, for example. The external interface 966 connects the image capturing device 960 and a printer at the time of printing an image, for example. Also, a drive is connected to the external interface 966 as necessary. A removable medium, such as a magnetic disk, an optical disc or the like, for example, is mounted on the drive, and a program read from the removable medium may be installed in the image capturing device 960. Furthermore, the external interface 966 may be configured as a network interface to be connected to a network such as a LAN, the Internet or the like. That is, the external interface 966 serves as transmission means of the image capturing device 960.

A recording medium to be mounted on the media drive 968 may be an arbitrary readable and writable removable medium, such as a magnetic disk, a magneto-optical disk, an optical disc, a semiconductor memory or the like, for example. Also, a recording medium may be fixedly mounted on the media drive 968, configuring a non-transportable storage section such as a built-in hard disk drive or an SSD (Solid State Drive), for example.

The control section 970 includes a processor such as a CPU, and a memory such as an RAM or an ROM. The memory stores a program to be executed by the CPU, program data, and the like. A program stored in the memory is read and executed by the CPU at the time of activation of the image capturing device 960, for example. The CPU controls the operation of the image capturing device 960 according to an operation signal input from the user interface 971, for example, by executing the program.

The user interface 971 is connected to the control section 970. The user interface 971 includes a button, a switch and the like used by a user to operate the image capturing device 960, for example. The user interface 971 detects an operation of a user via these structural elements, generates an operation signal, and outputs the generated operation signal to the control section 970.

In the image capturing device 960 configured in this manner, the image processing section 964 has a function of the image encoding device 10 and the image decoding device 60 according to the embodiment described above. Accordingly, in the case a block is partitioned by a boundary that can be formed in various shapes other than rectangle, it is possible to compensate motion with less amount of computation compared to existing methods.

### 6. Summary

Heretofore, the image encoding device 10 and the image decoding device 60 according to an embodiment have been described using FIGS. 1 to 33. According to the present embodiment, in the case a block set in an image is partitioned into a plurality of partitions using a boundary having an inclination and determining a motion vector of each partition, boundary information specifying a plurality of points of intersection of the perimeter of the block and the boundary is output for motion compensation that is based on the motion vector mentioned above. By transferring such boundary information from an image encoding device to an image decoding device, a reference pixel position of each partition can be recognized from a point of intersection of the perimeter of the block and the boundary with a small amount of computation, without performing geometric calculation, as in the existing methods, and motion compensation can be performed. As a result, the complexity of processes can be reduced in both encoding and decoding, making implementation of the devices easy, and enabling accumulation, delivery and reproduction of images to be performed at high speed.

Also, according to the present embodiment, the boundary information is information specifying each point of intersection of the perimeter of a block and a boundary based on a path along a route around the perimeter from a reference point set on the perimeter. According to such a configuration, also in the case of specifying a path on a per pixel basis, the estimation range does not change according to the inclination of the boundary. Thus, the processing load of the motion estimation at the time of encoding of an image can be reduced. Also, compared to the case of specifying an angle of inclination θ and a distance ρ on a per pixel basis, as in the existing methods, an optimal boundary can be selected from a greater number of boundary candidates.

Furthermore, according to the present embodiment, in the case two points of intersection belong to a common route set on the perimeter of a block, a second point of intersection that is farther away from a fixed reference point that is selected in advance may be specified based on a path not from the fixed reference point, but from a variable reference point. The dynamic range of the path of the second point of intersection is thereby made small, and the bit rate of a variable-length coded path can be reduced.

Still further according to the present embodiment, a plurality of routes are set on the perimeter of a block, and information specifying each point of intersection may include information identifying a route to which each point of intersection belongs and a path along the route from a reference point set on the route. In this case, since the dynamic ranges of the paths of two points of intersection are made small, the bit rate of variable-length coded paths can be further reduced.

Still further, according to the present embodiment, a path of each point of intersection may be quantized by a unit quantity larger than one pixel. Therefore, the bit rate of the boundary information can be further reduced. Also, by changing the unit quantity for quantization according to the block size, the bit rate of the boundary information can be reduced without greatly reducing the quality of motion compensation.

Additionally, in the present specification, an example has been mainly described where the information about intra prediction and the information about inter prediction is multiplexed to the header of the encoded stream, and the encoded stream is transmitted from the encoding side to the decoding side. However, the method of transmitting this information is not limited to such an example. For example, this information may be transmitted or recorded as individual data that is associated with an encoded bit stream, without being multiplexed to the encoded bit stream. The term “associate” here means to enable an image included in a bit stream (or a part of an image, such as a slice or a block) and information corresponding to the image to link to each other at the time of decoding. That is, this information may be transmitted on a different transmission line from the image (or the bit stream). Or, this information may be recorded on a different recording medium (or in a different recording area on the same recording medium) from the image (or the bit stream). Furthermore, this information and the image (or the bit stream) may be associated with each other on the basis of arbitrary units such as a plurality of frames, one frame, a part of a frame or the like, for example.

Heretofore, a preferred embodiment of the present disclosure has been described in detail while referring to the appended drawings, but the technical scope of the present disclosure is not limited to such an example. It is apparent that a person having an ordinary skill in the art of the technology of the present disclosure may make various alterations or modifications within the scope of the technical ideas described in the claims, and these are, of course, understood to be within the technical scope of the present disclosure.

### REFERENCE SIGNS LIST

10 Image encoding device (Image processing device)
46 Motion vector determination section (Boundary information generation section)
60 Image decoding device (Image processing device)
91 Boundary recognition section
96 Prediction section

1. An image processing device comprising:
a motion vector determination section for partitioning a block set in an image into a plurality of partitions using a boundary having an inclination, and determining a motion vector for each partition; and
a boundary information generation section for generating boundary information specifying a plurality of points of intersection of a perimeter of the block and the boundary.

2. The image processing device according to claim 1, wherein the boundary information is information specifying each point of intersection of the perimeter of the block and the boundary based on a path along a route around the perimeter from a reference point set on the perimeter.

3. The image processing device according to claim 2,
wherein the boundary information includes information specifying a first point of intersection based on a path from a first reference point, and information specifying a second point of intersection based on a path from a second reference point,
wherein the first reference point is a corner of the block that is selected in advance, and
wherein the second reference point is a corner located next, on the route, after the first point of intersection.

4. The image processing device according to claim 2,
wherein the perimeter is divided into a plurality of routes, and
wherein the information specifying each point of intersection includes information identifying a route to which each point of intersection belongs, and a path along each route from a reference point set on the route.

5. The image processing device according to claim 2, wherein the motion vector determination section quantizes the path for each point of intersection by a unit quantity larger than one pixel.

6. The image processing device according to claim 5, wherein the motion vector determination section sets the unit quantity for quantization of the path to be larger as a size of the block is larger.

7. The image processing device according to claim 4, wherein the perimeter is divided into four routes each corresponding to a side of the block.

8. The image processing device according to claim 4, wherein the perimeter is divided into two routes each including either a top side or a bottom side of the block and either a left side or a right side of the block.

9. The image processing device according to claim 8, wherein, in a case a first point of intersection and a second point of intersection belong to a common route, the boundary information includes information specifying the first point of intersection based on a path from a first reference point which is a starting point of the common route and information specifying the second point of intersection based on a path from a second reference point which is a corner located next on the common route after the first point of intersection.

10. The image processing device according to claim 1, further comprising:
an encoding section for encoding an image and generating an encoded stream; and
transmission means for transmitting the encoded stream generated by the encoding section and the boundary information.

11. An image processing method for processing an image, comprising:
partitioning a block set in an image into a plurality of partitions using a boundary having an inclination, and determining a motion vector for each partition which has been partitioned off; and
generating boundary information specifying a plurality of points of intersection of a perimeter of the block and the boundary.

12. An image processing device comprising:
a boundary recognition section for recognizing a boundary which has partitioned a block in an image into a plurality of partitions at a time of encoding of the image, based on boundary information specifying a plurality of points of intersection of a perimeter of the block and the boundary; and
a prediction section for predicting a pixel value for each partition which has been partitioned off by the boundary recognized by the boundary recognition section, based on a motion vector.

13. The image processing device according to claim 12, wherein the boundary information is information specifying each point of intersection of the perimeter of the block and the boundary based on a path along a route around the perimeter from a reference point set on the perimeter.

14. The image processing device according to claim 13,
wherein the boundary information includes information specifying a first point of intersection based on a path from a first reference point, and information specifying a second point of intersection based on a path from a second reference point,
wherein the first reference point is a corner of the block that is selected in advance, and
wherein the second reference point is a corner located next, on the route, after the first point of intersection.

15. The image processing device according to claim 13,
wherein the perimeter is divided into a plurality of routes, and
wherein the information specifying each point of intersection includes information indicating a route to which each point of intersection belongs, and a path along each route from a reference point set on the route.

16. The image processing device according to claim 13, wherein the boundary recognition section inverse quantizes the path for each point of intersection which has been quantized by a unit quantity larger than one pixel.

17. The image processing device according to claim 16, wherein the boundary recognition section inverse quantizes the path by a unit quantity that is larger as a size of the block is larger.

18. The image processing device according to claim 15, wherein the perimeter is divided into four routes each corresponding to a side of the block.

19. The image processing device according to claim 15, wherein the perimeter is divided into two routes each including either a top side or a bottom side of the block and either a left side or a right side of the block.

20. The image processing device according to claim 19, wherein, in a case a first point of intersection and a second point of intersection belong to a common route, the boundary information includes information specifying the first point of intersection based on a path from a first reference point which is a starting point of the common route and information specifying the second point of intersection based on a path from a second reference point which is a corner located next on the common route after the first point of intersection.

21. The image processing device according to claim 12, further comprising:
a receiving section for receiving an encoded stream which is the image which has been encoded and the boundary information; and
a decoding section for decoding the encoded stream received by the receiving section.

22. An image processing method for processing an image, comprising:
recognizing a boundary which has partitioned a block in an image into a plurality of partitions at a time of encoding of the image, based on boundary information specifying a plurality of points of intersection of a perimeter of the block and the boundary; and
predicting a pixel value for each partition which has been partitioned off by the recognized boundary, based on a motion vector.
